(19) United States
(12) Patent Application Publication
(10) Pub. No.: US 2006/0206221 A1
(43) Pub. Date: Sep. 14, 2006

(54) System and method for formatting multimode sound content and metadata

(76) Inventor: Randall B. Metcalf, Cantonment, FL (US)

Correspondence Address: PILLSBURY WINTHROP SHAW PITTMAN, LLP, P.O. BOX 10500, MCLEAN, VA, 22102, US

(21) Appl. No.: 11/358,063

(22) Filed: Feb. 22, 2006

Related U.S. Application Data
(60) Provisional application No. 60/654,867, filed on Feb. 22, 2005.

(51) Int. Cl. G06F 17/00; H04B 3/00; H04B 1/00

(52) U.S. Cl. 700/94; 381/80; 381/119

(57) ABSTRACT

A system and method for providing individual control over sound objects that are discretely received at a playback device. The sound objects may be representative of individual sound sources, and may include both sound content produced by the sound objects as well as other characteristics of the sound objects. The other characteristics of the sound objects may comprise one or more of a directivity pattern, position information, an object movement algorithm, and or other characteristics. In some instances, the other characteristics may establish an integral wave starting point, a relative position, and a scale for each of the N sound objects.

### RELATED APPLICATIONS

This application claims priority from U.S. Provisional Patent Application Ser. No. 60/654,867, filed Feb. 22, 2005, and entitled “SYSTEM AND METHOD FOR FORMATTING MULTIMODE SOUND CONTENT AND METADATA,” which is incorporated herein by reference. This application is related to U.S. Provisional Patent Application Ser. No. 60/622,695, filed Oct. 28, 2004, and entitled “A SYSTEM AND METHOD FOR RECORDING AND REPRODUCING SOUND EVENTS BASED ON MACRO-MICRO SOUND OBJECTIVES;” U.S. Provisional Patent Application Ser. No. 60/414,423, filed Sep. 30, 2002, and entitled “System and Method for Integral Transference of Acoustical Events”; U.S. patent application Ser. No. 08/749,766, filed Dec. 20, 1996, and entitled “Sound System and Method for Capturing and Reproducing Sounds Originating From a Plurality of Sound Sources”; U.S. patent application Ser. No. 10/673,232, filed Sep. 30, 2003, and entitled “System and Method for Integral Transference of Acoustical Events”; U.S. patent application Ser. No. 10/705,861, filed Dec. 13, 2003, and entitled “Sound System and Method for Creating a Sound Event Based on a Modeled Sound Field”; U.S. Pat. No. 6,239,348, issued May 29, 2001, and entitled “Sound System and Method for Creating a Sound Event Based on a Modeled Sound Field”; U.S. Pat. No. 6,444,892, issued Sep. 3, 2002, and entitled “Sound System and Method for Creating a Sound Event Based on a Modeled Sound Field”; U.S. Pat. No. 6,740,805, filed May 25, 2004, and entitled “Sound System and Method for Creating a Sound Event Based on a Modeled Sound Field”; each of which is incorporated herein by reference.

### FIELD OF THE INVENTION

The invention relates generally to a system and method for recording and reproducing three-dimensional sound events using a multimode content format.

### BACKGROUND OF THE INVENTION

Sound reproduction in general may be classified as a process that includes sub-processes. These sub-processes may include one or more of sound capture, sound transfer, sound rendering and other sub-processes. A sub-process may include one or more sub-processes of its own (e.g. sound capture may include one or more of recording, authoring, encoding, and other processes). Various transduction processes may be included in the sound capture and sound rendering sub-processes when transforming various energy forms, for example from physical-acoustical form to electrical form then back again to physical-acoustical form. In some cases, mathematical data conversion processes (e.g. analog to digital, digital to analog, etc.) may be used to convert data from one domain to another, such as, various types of codecs for encoding and decoding data, or other mathematical data conversion processes.

The sound reproduction industry has long pursued mastery over transduction processes (e.g. microphones, loudspeakers, etc.) and data conversion processes (e.g. encoding/decoding). Known technology in data conversion processes may yield reasonably precise results with cost restraints and medium issues being primary limiting factors in terms of commercial viability for some of the higher order codecs. However, known transduction processes may include several drawbacks. For example, audio components, such as, microphones, amplifiers, loudspeakers, or other audio components, generally imprint a sonic type of component colorization onto an output signal for that device which may then be passed down the chain of processes, each additional component potentially contributing its colorizations to an existing signature. These colorizations may inhibit a transparency of a sound reproduction system. Existing system architectures and approaches may limit improvements in this area.

A dichotomy found in sound reproduction may include the “real” versus “virtual” dichotomy in terms of sound event synthesis. “Real” may be defined as sound objects, or entities, with physical presence in a given space, whether acoustic or electronically produced. “Virtual” may be defined as entities with virtual presence relying on perceptional coding to create a perception of a source in a space not physically occupied. Virtual synthesis may be performed using perceptual coding and matrixed signal processing. It may also be achieved using physical modeling, for instance with technologies like wavefield synthesis which may provide a perception that objects are further away or closer than the actual physical presence of an array responsible for generating the virtual synthesis. Any synthesis that relies on creating a “perception” that sound objects are in a place or space other than where their articulating devices actually are may be classified as a virtual synthesis.

Existing sound recording systems typically use a number of microphones (e.g. two or three) to capture sound events produced by a sound source, e.g., a musical instrument and provide some spatial separation (e.g. a left channel and a right channel). The captured sounds can be stored and subsequently played back. However, various drawbacks exist with these types of systems. These drawbacks include the inability to capture accurately three dimensional information concerning the sound and spatial variations within the sound (including full spectrum “directivity patterns”). This leads to an inability to accurately produce or reproduce sound based on the original sound event. A directivity pattern is the resultant entity radiated by a sound source (or distribution of sound sources) as a function of frequency and observation position around the source (or source distribution). The possible variations in pressure amplitude and phase as the observation position is changed are due to the fact that different field values can result from the superposition of the contributions from all elementary sound sources at the field points. This is correspondingly due to the relative propagation distances to the observation location from each elementary source location, the wavelengths or frequencies of oscillation, and the relative amplitudes and phases of these elementary sources. It is the principle of superposition that gives rise to the radiation patterns characteristics of various vibrating bodies or source distributions. Since existing recording systems do not capture this 3-D information, this leads to an inability to accurately model, produce or reproduce 3-D sound radiation based on the original sound event.

On the playback side, prior systems typically use “Implosion Type” (IMT), or push, sound fields. The IMT or push sound fields may be modeled to create virtual sound events. That is, they use two or more directional channels to create a “perimeter effect” entity that may be modeled to depict virtual (or phantom) sound sources within the entity. The basic IMT paradigm, or mode, is “stereo,” where a left and a right channel are used to attempt to create a spatial separation of sounds. More advanced IMT modes include surround sound technologies, some providing as many as five directional channels (left, center, right, rear left, rear right), which creates a more engulfing entity than stereo. However, both are considered perimeter systems and fail to fully recreate original sounds. Implosion techniques are not well suited for reproducing sounds that are essentially a point source, such as stationary sound sources (e.g., musical instruments, human voice, animal voice, etc.) that radiate sound in all or many directions.

With these modes, “source definition” during playback is usually reliant on perceptual coding and virtual imaging. Virtual sound events in general do not establish well-defined interior fields with convincing presence and robustness for sources interior to a playback volume. This is partially due to the fact that sound is typically reproduced as a composite event reproduced via perimeter systems from outside-in. Even advanced technologies like wavefield synthesis may be deficient at establishing interior point sources that are robust during intensification.

With current technology, once a set of individual source signals have been mixed together to form a composite signal, it may not be possible to “unmix” the composite signal into its original constituent parts, at least not in a manner that retains the fidelity of the original signal for each source. Because of this “once mixed, always mixed” theorem, it may not be reasonable to expect a rendering engine to discretely reproduce source signals in their original form before they were mixed. Integrating the source signals together as discrete entities, conditioned for optimum performance based on a set of preferable macro/micro relationships between discrete sources, and between a playback venue and the sources may also pose problems for conventional rendering engines. The rendering engine may not be optimized in terms of “soundfield definition,” “discrete source amplification,” or other criteria, including the ability to reconfigure itself based on predetermined criteria (e.g., scaling criteria).

Other drawbacks and disadvantages of the prior art also exist.

### SUMMARY

An object of the invention is to overcome these and other drawbacks.

One aspect of the invention relates to a system and method for providing individual control over sound objects that are discretely received at a playback device. The sound objects may be representative of individual sound sources, and may include both sound content produced by the sound objects as well as other characteristics of the sound objects. The other characteristics of the sound objects may comprise one or more of a directivity pattern, position information, an object movement algorithm, and or other characteristics. In some instances, the other characteristics may establish an integral wave starting point, a relative position, and a scale for each of the N sound objects.

In one implementation, the playback device may receive synthesis information related to the sound objects. The sound objects may be assigned to output channels (e.g., loudspeaker system, individual loudspeakers, etc.) based on the received synthesis information and one or more characteristics of the output channels associated with the playback device (e.g., a number of output channels, a frequency response of one or more output channels, a directivity pattern of one or more output channels, etc.). The playback device may provide the user with an interface that enables the user to modify the assignment of the sound object to the playback channels.

Another aspect of the invention relates to a system that may provide N^{th} degree control and configurability for discrete audio objects throughout a transference process. The transference process may include a mechanism for segregated rendering of discrete audio objects such as, for example, an enhanced rendering engine that may create a “they are here” sound experience where an ensemble of original sources may be substantially reproduced within a reproduction environment. Combining audio objects for generalized composite rendering may be enabled at any point in the transference chain (e.g. recording and reproduction chain). However, the enhanced rendering engine may be capable of rendering discrete three-dimensional audio objects according to an original event model. An audio object may include typical sound information and may include, for example, tone/pitch information, amplitude information, rate of change information, and other sound information. An audio object may further include various “meta-data,” or INTEL, that corresponds to other characteristics of a sound that is being recorded and/or produced. For example, INTEL may include spatial characteristics of the sound, such as location of a point of origin, directional information, scaling information, movement algorithms, other spatial information, and information related to other characteristics of the sound.

In some embodiments, “mixing” may be implemented within a reproduction system. In some instances, artists and sound engineers will be equipped with an augmented set of tools for crafting their art. In such embodiments, the reproduction system may objectively define artist intent in terms of how an artist uses these new reference tools to create original events so that such events may be repeated and reproduced in an enhanced fashion. For example, factors for reproduction that may be accounted for via mixing may include environmental simulations, ambience of rooms and environments, and most mid field or far-field events that may reinforce a segregated object-oriented discrete output. Special effects like reverberation, movement algorithms for objects, moving in and out of real and virtual modes, etc. may be implemented with the “mixing” protocol. Artists may prefer at times to mix certain objects using traditional mixing procedures and then supplement the mix with discrete object-oriented non-mixed subsystems. Augmentation may occur in one or both directions, lifting discrete objects out of virtual mixes or folding down discrete objects into a mixed event.

In some embodiments of the invention, in a reproduction system, combinations of analogs and other generalizations may be implemented within the virtual space synthesis-physical space synthesis spectrum. In alternative embodiments, the reproduction system may include an integrated reproduction architecture and protocol. This may provide various enhancements such as, for example, enhancing both real and perceived definition among sources within a given sound event; establishing a basis by which each source's resolution may be augmented (because each source may retain a discrete reproduction appliance that may be customized for spatial and/or tonal accuracy); or proficiently amplifying a sound space (each source may retain a discrete amplification mechanism that may be separately controlled and harmonized with other discrete sources within a given sound event and/or harmonized with mixed events within a common sound event).

One aspect of the invention relates to a system and method for recording and reproducing three-dimensional sound events using a discretized, integrated macro-micro sound volume for reproducing a 3D acoustical matrix that reproduces sound including natural propagation and reverberation. The system and method may include sound modeling and synthesis that may enable sound to be reproduced as a volumetric matrix. The volumetric matrix may be captured, transferred, reproduced, or otherwise processed, as a spatial spectra of discretely reproduced sound events with controllable macro-micro relationships.

The system may include one or more recording apparatus for recording a sound event on a recording medium. The recording apparatus may record the sound event as one or more discrete entities. The discrete entities may include one or more micro entities and/or one or more macro entities. A micro entity may include a sound producing entity (e.g. a sound source), or a sound affecting entity (e.g. an object or element that acoustically affects a sound). A macro entity may include one or more micro entities. The system may include one or more rendering engines. The rendering engine(s) may reproduce the sound event recorded on the recorded medium by discretely reproducing some or all of the discretely recorded entities. In some embodiments, the rendering engine may include a composite rendering engine that includes one or more nearfield rendering engines and one or more farfield engines. The nearfield rendering engine(s) may reproduce one or more of the micro entities, and the farfield rendering engine(s) may reproduce one or more of the macro entities.

In some embodiments of the invention, sound may be modeled and synthesized based on an object-oriented discretization of a sound volume starting from focal regions inside a volumetric matrix and working outward to the perimeter of the volumetric matrix. An inverse template may be applied for discretizing the perimeter area of the volumetric matrix inward toward a focal region.

More specifically, one or more of the focal regions may include one or more independent micro entities inside the volumetric matrix that contribute to a composite volume of the volumetric matrix. A micro domain may include a micro entity volume of the sound characteristics of a micro entity. A macro domain may include a macro entity that includes a plurality of micro entities. The macro domain may include one or more micro entity volumes of one or more micro entities of one or more micro domains as component parts of the macro domain. In some instances, the composite volume may be described in terms of a plurality of macro entities that correspond to a plurality of macro domains within the composite volume. A macro entity may be defined by an integration of its micro entities, wherein each micro domain may remain distinct.

Because of the propagating nature of sound, sound events may be characterized as a macro-micro event. A exception may be a single source within an anechoic environment. This would be a rare case where a micro entity has no macro attributes, no reverb, and no incoming waves, only outgoing waves. More typically, sound event may include one or more micro entities (e.g. the sound source(s)) and one or more macro entities (e.g. the overall effects of various acoustical features of a space in which the original sound propagates and reverberates). A sound event with multiple sources may include multiple micro entities, but still may only include one macro entity (e.g. a combination of all source attributes and the attributes of the space or volume which they occur in, if applicable).

Since micro entities may be separately articulated, the separate sound sources may be separately controlled and diagnosed. An entity network may include one or more micro entities that may also be controlled and manipulated to achieve specific macro objectives within the entity network. In theory, the micro entities and macro entities that make up an entity network may be discretized to a wide spectrum of defined levels. As a result, this type of entity network lends itself well to process control and the optimization of process objectives.

In some embodiments of the invention, both an original sound event and a reproduced sound event may be discretized into nearfield and farfield perspectives. This may enable articulation processes to be customized and optimized to more precisely reflect the articulation properties of an original event's corresponding nearfield and farfield entities, including appropriate scaling issues. This may be done primarily so nearfield entities may be further discretized and customized for optimum nearfield wave production on an object-oriented basis. Farfield entity reproductions may require less customization, which may enable a plurality of farfield entities to be mixed in the signal domain and rendered together as a composite event. This may work well for farfield sources such as, ambient effects, and other plane wave sources. It may also work well for virtual sound synthesis where perceptual cues are used to render virtual sources in a virtual environment. In some preferred embodiments, both nearfield physical synthesis and farfield virtual synthesis may be combined.

In some embodiments of the invention, the system may include one or more rendering engines for nearfield articulation may be customizable, and discretized. Bringing a nearfield engine closer to an audience may add presence and clarity to an overall articulation process. Volumetric discretization of micro entities within a given sound event may not only help to establish a more stable physical sound stage, it may also allow for customization of direct sound articulation, entity by entity if necessary. This can make a significant difference in overall resolution since sounds may have unique articulation attributes in terms of wave attributes, scale, directivity, etc. the nuances of which get magnified when intensity is increased.

In various embodiments of the invention, the system may include one or more farfield engine. The farfield engines may provide the a plurality of micro entity volumes included within a macro domain related to the farfield entities of a sound event.

According to one embodiment, the two or more independent engines may work together to produce precise analogs of sound events, captured or specified. Farfield engines contribute to this compound approach by articulating farfield entities, such as, farfield sources, ambient effects, reflected sound, and other farfield entities, in a manner optimum to a farfield perspective. Other discretized perspectives can also be applied.

For instance, in some embodiments, an exterior noise cancellation device could be used to counter some of the unwanted resonance created by an actual playback room. By reducing or eliminating the effects of a playback room, “double ambience” may be reduced or eliminated leaving only the ambience of an original event (or of a reproduced event if source material is recorded dry) as opposed to a combined resonating effect created when the ambience of an original event's space is superimposed on the ambience of a reproduced event's space (“double ambience”). It may be desirable to have as much control and diagnostics over this process as possible to reduce or eliminate the unwanted effects and add or enhance desirable effects.

While some or all of the micro entities may retain discreteness throughout a transference process including the final transduction process, articulation, some or all of the entities to be mixed if so desired. For instance, to create a derived ambient effect, or be used within a generalized commercial template where a limited number of channels might be available, some or all of the discretely transferred entities may be mixed prior to articulation. Therefore, the data based functions including control over the object data that corresponds to a sound event may be enhanced to allow for both discrete object data (dry or wet) and mixed object data (matrixed according to a perceptually based algorithm) to flow through an entire processing chain to compound rendering engine that may include one or more nearfield engines and one or more farfield engines, for final articulation. In other words, object data may be representative of three-dimensional sound objects that can be independently articulated (micro entities) in addition to being part of a combined macro entity.

The virtual vs. real dichotomy (or virtual sound synthesis vs. physical sound synthesis), outlined above, may break down similar to the nearfield-farfield dichotomy. Virtual space synthesis in general may operate well with farfield architectures and physical space synthesis in general may operate well with nearfield architectures (although physical space synthesis may also integrate the use of farfield architectures in conjunction with nearfield architectures). So, the two rendering perspectives may be layered within a volume's space, one optimized for nearfield articulation, the other optimized for farfield articulation, both optimized for macro entities, and both working together to optimize the processes of volumetric amplification among other things. Other perspectives may exist that may enable sound events to be discretized to various levels.

Layering the two articulation modes in this manner may improve the overall prospects for rendering sound events more optimally but may also presents new challenges, such as distinguishing when rendering should change over from virtual to real, or determining where the line between nearfield and farfield may lie. In order for rendering languages to be enabled to deal with these two dichotomies, a standardized template may be established defining nearfield discretization and farfield discretization as a function of layering real and virtual entities (other functions can be defined as well), resulting in a macro-micro rendering template for creating definable repeatable analogs.

In some embodiments of the invention, nearfield engines may be object-oriented in nature, they may also be viewed and/or used simply as direct sound articulators, separate from farfield articulators. By segregating articulation engines for direct and indirect sound, a sound space may be more optimally energized resulting in a more well defined explosive sound event.

According to various embodiments of the invention, the system may include using physical space synthesis technologies for nearfield articulations while using virtual space synthesis technologies for farfield articulations, each optimized to work in conjunction with the other (additional functions for virtual space synthesis-physical space synthesis discretization may exist). Nearfield engines may be further discretized and customized.

While a compound rendering engine may be used for the purposes of optimizing an articulation process in a more object-oriented integrated fashion. Other embodiments may exist. For example, a primarily physical space synthesis system may be use. In such embodiments, all, or substantially all, aspects of an original sound event may be synthetically cloned and physically reproduced in an appropriately scaled space. However, the compound approach marrying virtual space synthesis and physical space synthesis may provide various enhancements, such as, economic, technical, practical, or other enhancements. However it will be appreciated that if enough space is available within a given playback venue, a sound event may be duplicated using physical space synthesis methods only.

In various embodiments of the invention, object-oriented discretization of entities may enable improvements in scaling to take place. For example, if generalizations are required due to budget or space restraints nearfield scaling issues may produce significant gains. Farfield sources may be processed and articulated using one or more separate rendering engines, which may also be scaled accordingly. As a result very impressive macro events may be reproduced within a given venue (room, car, etc.) using relatively small compound rendering engines. Sound intensification is one of audio's unique attributes.

In some embodiments of the invention, physical space synthesis and virtual space synthesis may be combined and harmonized to various degrees to enhance various aspects of playback. This simultaneous utilization of physical space synthesis and virtual space synthesis may create a continuum of applications that may blend (or augment) modes that require different coding schemes. These various modes and/or coding schemes may be manipulated via a structural protocol and/or a common data set. In other words, some embodiments may include a systematic approach for blending two or more modes in a predetermined (or random if desirable), reproducible, calibrated fashion. For example, this may be accomplished via partitioned coding where code for physical synthesis may be separately transferred and/or stored for harmonization with virtual synthesis code, also partitioned, if desirable. Alternatively, coding transfer schemes based on multiplexing may be used to transfer the data as not partitioned, converted back to partitioned data via demultiplexing post transfer of code.

According to various embodiments of the invention, separate sound transducers may capture sound events generated by a plurality of sound sources using a configurable number of channels. In some instances, one channel (mono) may be captured for each of the plurality of sound sources. This may correspond to physical space synthesis of the sound events generated by the sound sources. Part or all of the physical channel code may be folded (mixed down) into a virtual code that may correspond to virtual space synthesis of the common sound events, if necessary or desired. Conversely, once the physical channels have been folded into the virtual code, the virtual channels may be lifted out in a reverse process. This may enable various options related to how multimode content formats can be used both creatively and scientifically. Augmentation in both directions along a physical space synthesis-virtual space synthesis continuum may be enabled.

In some embodiments, model-based functions may also be used within the multimode content format, and may be enhanced. These embodiments may use volumetric parameterization for defining sound volumes (or spaces) in terms of defining size, shape, acoustical attributes, and other applicable parameters. Multimode format may include an object-oriented supermodular deconstruct-reconstruct protocol for defining model-based criteria for some or all sound objects within a volume. Model-based criteria may include individual space and direction attributes (micro entities), or be a combination of object spatial and directional criteria that all together form a macro-micro model based event. The tonal attributes may be classified as data-based criteria, or may, fall into the category of model-based criteria. Separating the terms into data-based and model-based criteria may enable enhancement of the system for reproducing macro-micro sound events using a multimode content format. Metadata may be used to control the system's model-based functions, while the data-based content may provide the sound code itself. Combining model-based functions with data-based functions in this way may enable reduction of the amount of data needed for what may otherwise be an extensive amount of data to reproduce all of the object sound waves, mixed sound waves, and combination sound waves. The combination of these functions may enable enhanced reproduction of the common sound event in instances where one mono datastream per object is captured, processed, and/or reproduced. For example, metadata may accompany the mono datastream of code to provide space and direction parameters for object outputs, and macro-micro outputs may be realized using a network of mono channels for the physical synthesis objects. The virtual synthesis code, which may not be limited to one channel in a single event, may require its own matrix of signals working together to produce the virtual space and virtual sources. In some instances, this may enable interior fields to be discretely articulated and controlled as part of a compound rendering approach where the midfield and farfield sources may be rendered via a separate perimeter architecture using separate code as described.

According to various embodiments of the invention, a multimode content format may be used to manage a complex sound event. The complex sound event may comprise a plurality of independent sound events integrated together to achieve a specific macro-micro dynamic as defined by an original model (captured or prescribed). The multimode content formats may provide a network of content formats that may drive multimode systems. In some instances, both an original event and a reproduced event may be discretized into nearfield and farfield perspectives. This may enable articulation processes to be customized and optimized to reflect the articulation properties of an original event's corresponding nearfield (NF) and farfield (FF) dynamics including, for example, appropriate scaling issues. This may be done to enable nearfield sources to be further discretized and customized for optimum nearfield wave production on an object-oriented basis. The further away a reproduction architecture is, or any sound object, the longer sound produced by the reproduction architecture has to expand in all directions and eventually propagate into a plane wave. Discrete object(s) space and direction attributes may be very instrumental in establishing an augmented sense of realism. Farfield source reproductions may require less customization since sound objects may be mixed in the signal domain and rendered together as a composite event.

Another aspect of the invention may relate to a transparency of sound reproduction. By discretely controlling some or all of the micro entities included in a sound event, the sound event may be recreated to compensate for one or more component colorizations through equalization as the sound event is reproduced.

Another object of the present invention is to provide a system and method for capturing an entity, which is produced by a sound source over an enclosing surface (e.g., approximately a 360° spherical surface), and modeling the entity based on predetermined parameters (e.g., the pressure and directivity of the entity over the enclosing space over time), and storing the modeled entity to enable the subsequent creation of a sound event that is substantially the same as, or a purposefully modified version of, the modeled entity.

Another object of the present invention is to model the sound from a sound source by detecting its entity over an enclosing surface as the sound radiates outwardly from the sound source, and to create a sound event based on the modeled entity, where the created sound event is produced using an array of loud speakers configured to produce an “explosion” type acoustical radiation. Preferably, loudspeaker clusters are in a 360° (or some portion thereof) cluster of adjacent loudspeaker panels, each panel comprising one or more loudspeakers facing outward from a common point of the cluster. Preferably, the cluster is configured in accordance with the transducer configuration used during the capture process and/or the shape of the sound source.

According to one object of the invention, an explosion type acoustical radiation is used to create a sound event that is more similar to naturally produced sounds as compared with “implosion” type acoustical radiation. Natural sounds tend to originate from a point in space and then radiate up to 360° from that point.

According to one aspect of the invention, acoustical data from a sound source is captured by a 360° (or some portion thereof) array of transducers to capture and model the entity produced by the sound source. If a given entity is comprised of a plurality of sound sources, it is preferable that each individual sound source be captured and modeled separately.

A playback system comprising an array of loudspeakers or loudspeaker systems recreates the original entity. Preferably, the loudspeakers are configured to project sound outwardly from a spherical (or other shaped) cluster. Preferably, the entity from each individual sound source is played back by an independent loudspeaker cluster radiating sound in 360° (or some portion thereof). Each of the plurality of loudspeaker clusters, representing one of the plurality of original sound sources, can be played back simultaneously according to the specifications of the original entitys produced by the original sound sources. Using this method, a composite entity becomes the sum of the individual sound sources within the entity.

To create a near perfect representation of the entity, each of the plurality of loudspeaker clusters representing each of the plurality of original sound sources should be located in accordance with the relative location of the plurality of original sound sources. Although this is a preferred method for EXT reproduction, other approaches may be used. For example, a composite entity with a plurality of sound sources can be captured by a single capture apparatus (360° spherical array of transducers or other geometric configuration encompassing the entire composite entity) and played back via a single EXT loudspeaker cluster (360° or any desired variation). However, when a plurality of sound sources in a given entity are captured together and played back together (sharing an EXT loudspeaker cluster), the ability to individually control each of the independent sound sources within the entity is restricted. Grouping sound sources together also inhibits the ability to precisely “locate” the position of each individual sound source in accordance with the relative position of the original sound sources. However, there are circumstances which are favorable to grouping sound sources together. For instance, during a musical production with many musical instruments involved (i.e., full orchestra). In this case it would be desirable, but not necessary, to group sound sources together based on some common characteristic (e.g., strings, woodwinds, horns, keyboards, percussion, etc.).

In applying volumetric geometry to objectively define volumetric space and direction parameters in terms of the placement of sources, the scale between sources and between room size and source size, the attributes of a given volume or space, movement algorithms for sources, etc., may be done using a variety of evaluation techniques. For example, a method of standardizing the volumetric modeling process may include applying a focal point approach where a point of orientation is defined to be a “focal point” or “focal region” for a given sound volume.

According to various embodiments of the invention, focal point coordinates for any volume may be computed from dimensional data for a given volume which may be measured or assigned. Since a volume may have a common reference point, its focal point, everything else may be defined using a three dimensional coordinate system with volume focal points serving as a common origin. Other methods for defining volumetric parameters may be used as well, including a tetrahedral mesh, or other methods. Some or all of the volumetric computation may be performed via computerized processing. Once a volume's macro-micro relationships are determined based on a common reference point (e.g. its focal point), scaling issues may be applied in an objective manner. Data based aspects (e.g. content) can be captured (or defined) and routed separately for rendering via a compound rendering engine.

For applications that occur in open space without full volumetric parameters (e.g. a concert in an outdoor space), the missing volumetric parameters may be assigned based on sound propagation laws or they may be reduced to minor roles since only ground reflections and intraspace dynamics among sources may be factored into a volumetric equation in terms of reflected sound and other ambient features. However even under these conditions a sound event's focal point (used for scaling purposes among other things) may still be determined by using area dimension and height dimension for an anticipated event location.

By establishing an area based focal point with designated height dimensions even outdoor events and other sound events not occurring in a structured volume may be appropriately scaled and translated from reference models.

These and other objects of the invention are accomplished according to one embodiment of the present invention by defining an enclosing surface (spherical or other geometric configuration) around one or more sound sources, generating a entity from the sound source, capturing predetermined parameters of the generated entity by using an array of transducers spaced at predetermined locations over the enclosing surface, modeling the entity based on the captured parameters and the known location of the transducers and storing the modeled entity. Subsequently, the stored entity can be used selectively to create sound events based on the modeled entity. According to one embodiment, the created sound event can be substantially the same as the modeled sound event. According to another embodiment, one or more parameters of the modeled sound event may be selectively modified. Preferably, the created sound event is generated by using an explosion type loudspeaker configuration. Each of the loudspeakers may be independently driven to reproduce the overall entity on the enclosing surface.

### BRIEF DESCRIPTION OF THE DRAWINGS

FIG. 1 illustrates a system for recording and reproducing original sound events, according to some embodiments of the invention.

FIG. 2 illustrates an original sound source, in accordance with some of the embodiments of the invention.

FIG. 3 illustrates a rendering engine for reproducing the original sound source, according to various embodiments of the invention.

FIG. 4 illustrates a method of recording and reproducing sound events, in accordance with various embodiments of the invention.

FIG. 5 illustrates a system for recording and reproducing sound events, in accordance with some of the embodiments of the invention.

FIG. 6 illustrates various systems for reproducing sound events, according to some of the embodiments of the invention.

FIG. 7 illustrates a system for reproducing sound events, in accordance with various embodiments of the invention.

FIG. 8 illustrates a system for reproducing sound events that integrates near-field and far-field rendering engines, according to various embodiments of the invention.

FIG. 9 illustrates various principles for reproducing spatial parameters of a sound event, according to some of the embodiments of the invention.

FIG. 10 illustrates an analog of an original sound event being degraded or upgraded via varying levels of optimization, depending on the degree of object-oriented segregation implemented, in accordance with various embodiments of the invention.

FIG. 11 illustrates a composite rendering engine, according to various embodiments of the invention.

FIG. 12 illustrates systems for reproducing sound events with varying degrees of augmentation for customized reproduction, according to some of the embodiments of the invention.

FIG. 13 illustrates a system for reproducing sound events, in accordance with various embodiments of the invention.

FIG. 14 illustrates a system for formatting multimode sound content and metadata, in accordance with some embodiments of the invention.

FIG. 15 illustrates a system for formatting multimode sound content and metadata, in accordance with some embodiments of the invention.

FIG. 16 illustrates various systems for reproducing sound events, according to some of the embodiments of the invention.

FIG. 17 illustrates a system for formatting multimode sound content and metadata, in accordance with some embodiments of the invention.

FIG. 18 illustrates various systems for reproducing sound events using multimode sound content and metadata, in accordance with some embodiments of the invention.

FIG. 19 illustrates a system for recording and/or generating sound events using multimode sound content and metadata, according to various embodiments of the invention.

FIG. 20 illustrates a composite rendering engine, according to some embodiments of the invention.

FIG. 21 illustrates a system for reproducing sound events, in accordance with some of the embodiments of the invention.

### DETAILED DESCRIPTION OF THE DRAWINGS

One aspect of the invention relates to a system that may provide N^{th} degree control and configurability for discrete audio objects throughout a transference process. The transference process may include a mechanism for segregated rendering of discrete audio objects, such as, for example, an enhanced rendering engine capable of creating a “they are here” experience where the ensemble of original sources may be substantially reproduced within a reproduction environment. Combining audio objects for generalized composite rendering may be enabled at any point in the transference chain (e.g. recording and reproduction chain). However, the enhanced rendering engine may be capable of rendering discrete three-dimensional audio objects according to an original event model. An audio object may include typical sound information, and may include, for example, tone/pitch information, amplitude information, rate of change information, and other sound information. The audio object may further include various “meta-data,” or INTEL, that corresponds to other characteristics of a sound that is being recorded and/or produced. For example, INTEL may include spatial characteristics of the sound, such as location of a point of origin, directional information, scaling information, movement algorithms, other spatial information, and information related to other characteristics of the sound.

In some embodiments, “mixing” may be implemented within a reproduction system. In some instances, artists and sound engineers will be equipped with an augmented set of tools for crafting their art. In such embodiments, the reproduction system may objectively define artist intent in terms of how an artist uses these new reference tools to create original events so that such events may be repeated and reproduced in an enhanced fashion. For example, factors for reproduction that may be accounted for via mixing may include environmental simulations, ambience of rooms and environments, and most mid field or far-field events that may reinforce a segregated object-oriented discrete output. Special effects like reverberation, movement algorithms for objects, moving in and out of real and virtual modes, etc. may be implemented with the “mixing” protocol. Artists may prefer at times to mix certain objects using traditional mixing procedures and then supplement the mix with discrete object-oriented non-mixed subsystems. Augmentation may occur in one or both directions, lifting discrete objects out of virtual mixes or folding down discrete objects into a mixed event.

In some embodiments of the invention, in a reproduction system, combinations of analogs and other generalizations may be implemented within the virtual space synthesis-physical space synthesis spectrum. In alternative embodiments, the reproduction system may include an integrated reproduction architecture and protocol. This may provide various enhancements such as, for example, enhancing both real and perceived definition among sources within a given sound event; establishing a basis by which each source's resolution may be augmented (because each source may retain a discrete reproduction appliance that may be customized for spatial and/or tonal accuracy); or proficiently amplifying a sound space (each source may retain a discrete amplification mechanism that may be separately controlled and harmonized with other discrete sources within a given sound event and/or harmonized with mixed events within a common sound event).

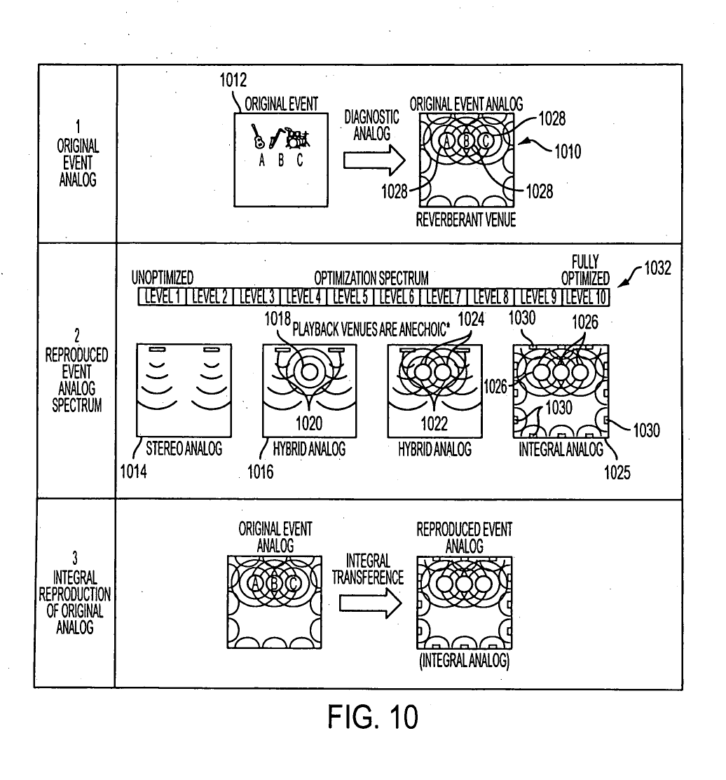

FIG. 10 is an exemplary illustration according to an embodiment of the invention that depicts, among other things, how an analog 1010 of an original sound event 1012 may be degraded or upgraded via varying levels of optimization, depending on the degree of object-oriented segregation implemented. For example, analog 1010 may be degraded to a stereo mode 1014, a first hybrid mode 1016 that may include a single physical space synthesis rendering engine 1018 and one or more virtual space synthesis rendering engines 1020. The virtual space synthesis rendering engines 1020 may include a second hybrid mode 1021 that may include two physical space synthesis rendering engines 1022 and one or more virtual space synthesis rendering engines 1024, and/or a integral analog mode 1025 that includes a number of physical space synthesis rendering engines 1026 that may correspond to a number of sound sources 1028 included in the analog 1010 and virtual space synthesis rendering engines 1030. As additional sound objects within original sound event 1012 be segregated and defined, a reproduced analog may evolve closer to analog 1010. This modular evolutionary approach for building up systems, in the direction of a fully optimized integral analog, may serve as a baseline reference for generalizing hardware and protocol for commercial viability of technologies. This approach may provide a reference guideline for folding discrete physical objects into a given virtual sound landscape.

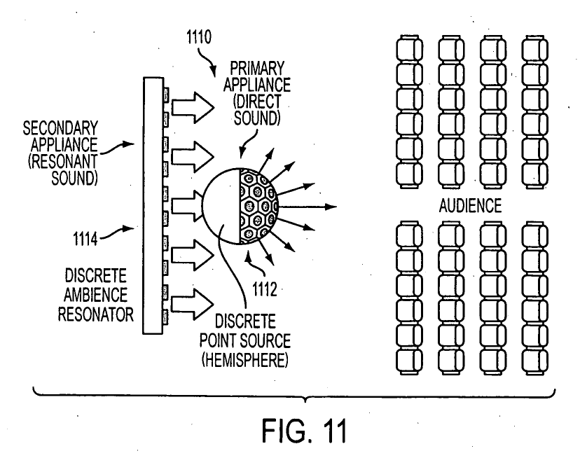

FIG. 11 is an exemplary illustration of a compound rendering engines 1110. Compound rendering engine 1110 may include a primary appliance 1112 and a secondary appliance 1114. Rendering engine 1110 may be configured for vocal reproductions. Rendering engine 1110 may be designed to simulate a high resolution vocal wavefront in terms of point source propagation of a modeled wavefront (vocal source for this example). Primary appliance 1112 may include filtering dynamics for a phased loudspeaker array, simulating magnitude and direction of a hemi analog for vocals. Multimode content may be used here. The point source vocals may require an array of one mode of signals. A second content mode may be used for secondary appliance 1114. In some instances, it may be possible to derive certain modes from certain other modes. In other instances, this may not be possible. For instance, a group of object-oriented mono signals may be mixed down into a good stereo mix, but without the original mono tracks it may not be feasible to return a given stereo mix to discrete mono signal(s) representing each sound object that was part of an original sound event.

In some embodiments, secondary appliance 1114 may be designed to simulate resonance reinforcement as a means of augmenting the direct sound produced by primary appliance 11 12. By segregating these two functions (as opposed to attempting to achieve both effects via the same appliance using, for example, flat panel loudspeaker arrays and signal processing schemes), each separate appliance may be configured for a specific purpose. Primary appliance 11 12 may project an amplified version of a near-field, point source wavefront while secondary appliance 1114 may be optimized for rendering a composite, flat wavefront for rendering reinforced resonance or other ambient effects. The point source wavefront produced by primary appliance 1112 may be augmented by an ambient wavefront produced by secondary appliance 1114. Together these wavefronts may propagate a compound wavefront to an audience. Compound rendering engine 1110 may not, in certain embodiments, require surround channels and may be used for public address systems in addition to various musical applications. Multimode content may be required whether it is captured or derived, to drive a multimode rendering engine of the type proposed.

According to an embodiment of the invention, compound rendering engine 1110 may discretely change the nature of the resonance of reproduced sounds, or other effects, to match a venue's given dynamics while retaining a pure representation of an original vocal articulation. Furthermore, the segregated nature of rendering engine 1110 may allow for a more precise mechanism for amplifying a vocal track without distortion to the natural wave shape of vocal sound waves and without amplifying resonant sound inaccurately. Multimode content may enable these types of compositions and controls. Active acoustic feedback signals may augment the multimode code to enhance matching object and/or subjective criteria (e.g. consumer edification level).

Returning to FIG. 10, the manner in which the “physical” events can be folded down into the “virtual” domain and likewise any of the “physical” objects can be lifted out of the “virtual” is illustrated in an exemplary manner. For example, the illustrated embodiment may demonstrate how analog 1010 for original event 1012 may exist in different forms in terms of establishing an optimization spectrum 1032 from level 1 to level 10 in the direction of reproducing a result with an enhanced precision or enhanced subjective appeal. It will be appreciated that the spectrum shown is for illustrative purposes only, and that other levels and/or criteria may be used to establish an optimization spectrum. In spectrum 1032, discrete sources may be lifted out of a virtual event to move the overall sound event along optimization spectrum 1032. A multimode content format may facilitate these types of “liftouts” and the reverse process of “folding down.” Optimization may enable the multimode compound rendering engines to blend and augment the final outcome to any level and degree along a physical-virtual continuum.

According to various embodiments of the invention, it may be possible to prescribe any simple or complex sound event for use as an original event (sound production) or as a reproduced event (sound reproduction), based on content structure either captured from an original event or created by an artist or user. For example, a user may prescribe a lion's roar scaled for a small indoor venue using a standardized articulation reference system. In such embodiments, “perspective” may be prescribed, mandating whether or not the lions are in the near-field or far-field, as the integrated wave shape changes depending on a source's originating perspective. A multimode rendering engine may enable various sound configurations to be prescribed. These multimode systems may require multimode content which may include metadata for informing and instructing a given reproduction system with intelligence capabilities for understanding and actualizing the metadata instructions which may also include various types of default settings for non-intelligent playback systems.

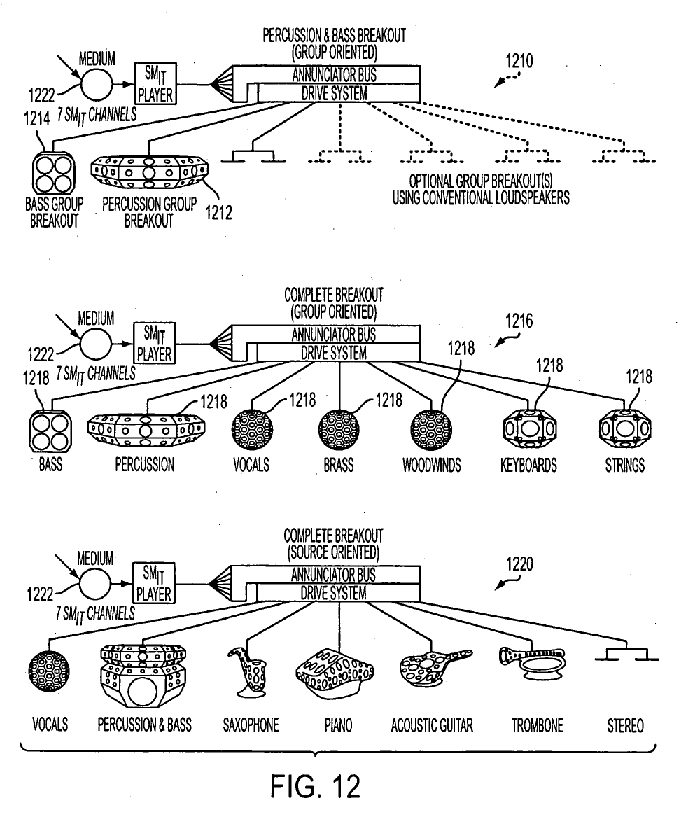

FIG. 12 is an exemplary illustration of an embodiment that may be used for recording and/or reproducing (or producing without recording) music. For music applications, a suitable composite rendering engine may include applying an integrated, object-oriented, distributed near-field engine for optimum musical instrument reproduction while using a surround sound/stereo far-field engine for ambience and reinforcements.“With the use of an integrated, distributed near-field engine, one or more musical instruments or musical instrument groups may be segregated and customized for reproduction and amplification of acoustical properties unique to a given source or family of sources. In some instances, various musical instruments (and instrument families) may be phased in to the overall macro presentation over time as part of a compound rendering architecture's near-field engine via a calibrated modular design function. The object-oriented concept may serve as one mode of a multimode content yet there may be submodes within each of these major modes.

In some embodiments of the invention, an entry level system 1210 may be comprised of a percussion rendering engine 1212 and a bass breakout rendering engine 1214, rendering the remaining instrument groups together via an existing stereo or surround sound setup. Entry level system 1210 may be conceptualized as a type of “augmented stereo”. As resources and/or budgets allow, further group breakout may be added modularly to progress toward an expanded commercial system 1216. Expanded commercial system 1216 may include a complete group breakout with seven (or other number of) customized rendering appliances 1218. For rendering some sound events, where one or more sources are constant (enabling full optimization to be applied along the source's optimization spectrum), a congruent-shaped appliance may be used, as is illustrated within a specialized commercial system 1220. This type of congruent wave rendering may prove valuable when high levels of amplification may be required such as, for example, when a source's output is projected onto an audience within a very near-field. A source's congruent wave shape may evolve into a spherical wave. However, for an enhanced accuracy at higher levels of amplification or for nearfield consumption, a congruent-shaped rendering appliance may be used.

According to an embodiment of the invention, input data may be the same for rendering systems 1210, 1216, and 1220. In other words, each system may not require a separate encode. Rather, the different outcomes may result from data processing that may occur after decoding the input data from a storage medium 1222. In such instances, submodes may occur downline from the major modes. Alternatively, the modes may be arranged in any order or any functional matrix that contributes to a piece of art and/or its reproduction.

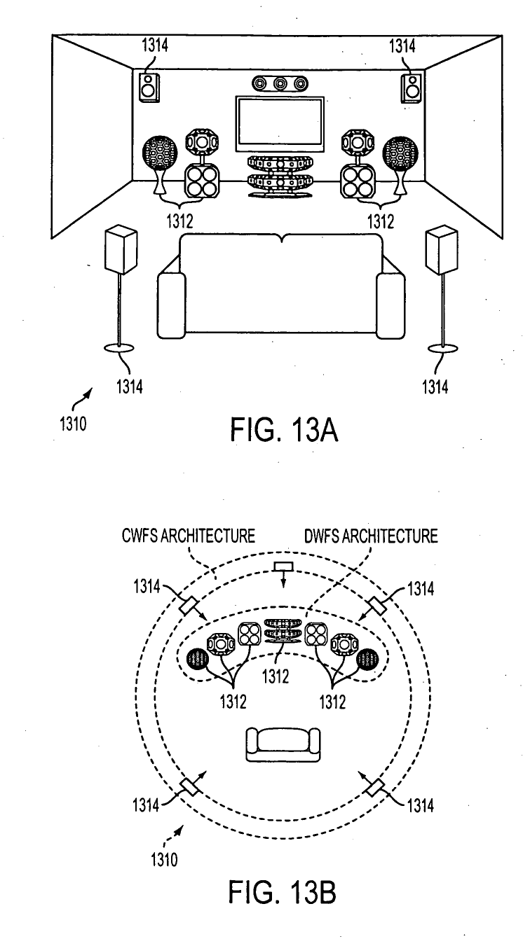

FIGS. 13A and 13B are exemplary illustrations of a multimode rendering system 1310, according to an embodiment of the invention. Multimode rendering system 1310 may, for example, be used for cinema applications. In such embodiments, one or more near-field (e.g., physical space synthesis) rendering engines 1312 may be configured for music applications or other applications, and may be used for a movie's musical soundtrack and/or some or all dialog tracks. Multimode rendering system 1310 may include one or more far-field (or virtual space synthesis) rendering engines 1314. Far-field rendering engines 1314 may be used for environmental ambience, moving sound like an airplane flyover or bombs exploding around an audience, and/or other applications. Other combinations of these and other compound rendering engines may also be implemented. Multimode content formats may be used to feed the compound rendering engines with an array of non-mixed and mixed coded signals, and, in some instances, metadata, for each data stream, whether physical-oriented or virtual-oriented.

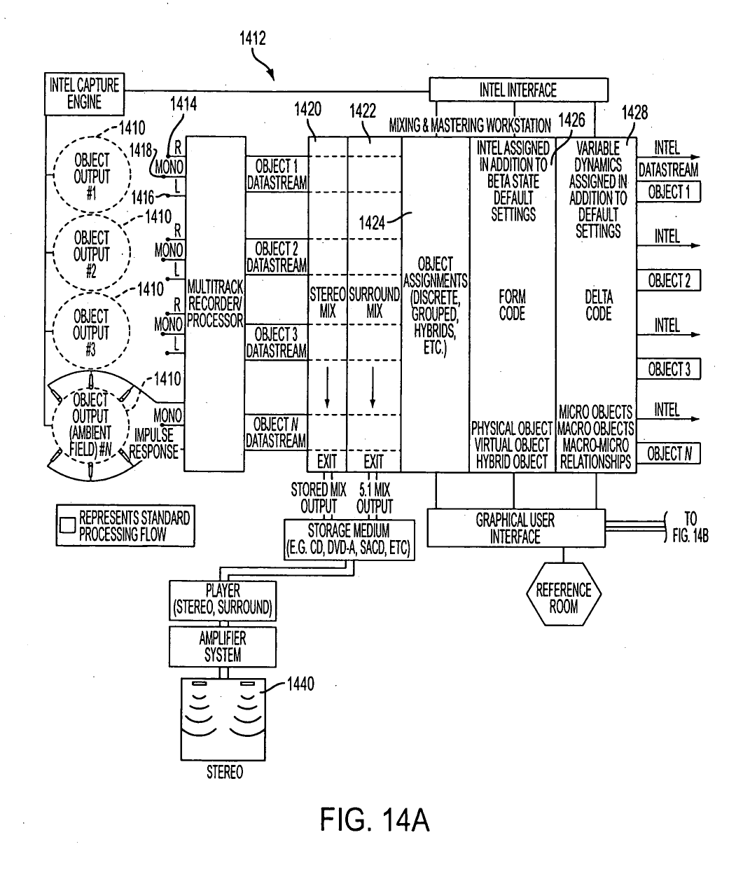

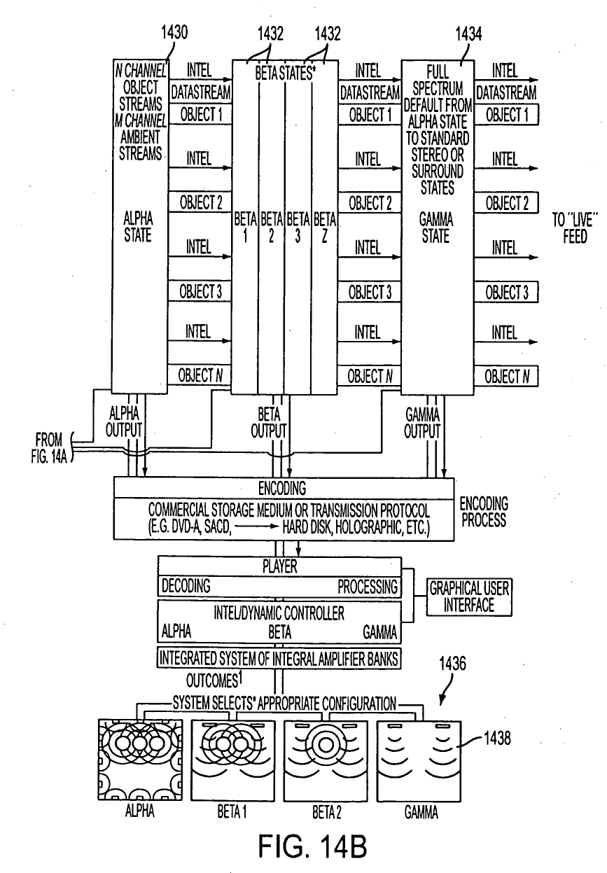

FIG. 14 is an exemplary illustration of a progression of recording and reproduction chain according to an embodiment of the invention. Information corresponding to each of a plurality of objects 1410 (e.g. musical instrument, vocal, etc.) may be separately captured and may be processed as a standalone entity prior to reaching a mixing and mastering workstation 1412. INTEL (or metadata) for each object may be extracted and/or assigned during the capture process or may be assigned (but not captured) during the mixing/mastering processes. This may enable each discrete object 1410 to have attributes assigned (or captured), in addition to tonal attributes typically captured or synthesized (e.g. midi). For example, capturing or assigning INTEL for discrete objects 1410 may include capturing and/or assigning spatial attributes to discrete objects 1410.

In some embodiments of the invention, spatial information captured and/or assigned as INTEL may include, for example, object directivity patterns, relative positions of objects, object movement algorithms, or other information. The spatial information may enable objects 1410 to be defined with some particular attributes from the beginning of the recording and reproduction chain, but may enable compromises, fold-downs, and other backward compatible adjustments. Therefore, the INTEL, as well as its ability to be manipulated, may be used in a variety of ways downline in the chain, even during reproduction.

According to an embodiment of the invention, simplified applications and generalized systems may be used to reproduce the objects. In such instances, knowledge and/or detectability of a given object's integral state, both tonal-wise and spatial-wise, may provide various enhancements to reproduction. For example, integral wave equations for discrete objects 1410 may be combined, reduced, separated, subsequent to being mixed, etc. In some embodiments, INTEL may provide a baseline established from an object's integral wave starting point and relative position and scale. Other attributes may be defined at this point as well, e.g. default settings, delta functions, etc. Each object 1410 may become fully defined both in tone and space and in any or all directions. Each object 1410 may be defined individually and/or as part of a macro event where it serves as a micro object networked together with other micro objects to form a macro-micro sound event with multimode content structure.

In various embodiments of the invention, INTEL may be harvested, cataloged, and automated via one or more digital workstations and INTEL banks/libraries. Alternatively, as illustrated in FIG. 14, each object 1410 may obtain its INTEL data either via capture or assignment.

In some embodiments, three signals may be captured. For example, a mono signal may be captured for a physical space synthesis object-oriented system (mono+INTEL). Alternatively, a left and right microphone 1414 and 1416 may be used in addition to a mono microphone 1418 to enable datastreams representing virtual tracks. Physical space synthesis fields may be implemented using one microphone (mono) in instances where spatial INTEL for object 1410 has already been harvested or is to be assigned at a later phase of the mastering process.

In one embodiment of the invention, objects 1410 may be recorded and mixed/mastered for multichannel modes from stereo to 5.1 discrete surround sound at a stereo mix station 1420 and/or a surround sound mix station 1422. These modes typically rely on mixing and virtual rendering via perceptually coded material. These traditional type “mixed” versions of a given sound event may be provided as optional material for consumer playback machines to use if they are not multimode capable. This may provide for backward compatibility for the content side.

According to an embodiment of the invention, mix stations 1420 and 1422 enable a multimode reproduction system to offer standard stereo and surround mix downs. These standard mix downs may enable a user to reproduce objects 1410 via, for example, conventional reproduction setups. They may also serve as ambient channels for a more fully enabled multimode reproduction system. In these instances, modes may be added which may be used for object-oriented physical synthesis or noise cancellation, etc. This channeling multimode content may enable both virtual (ambient) type rendering engines and physical type rendering engines to be utilized according to specific roles that may enhance overall sound reproduction. For example, rendering engine types may be determined first by artists/producers and then modified from there, if necessary, as mandated by transfer technologies, playback hardware, and/or consumer preferences. Default settings may be established to accommodate situations when needed.

According to an embodiment of the invention, the recording and reproduction chain may include an object assignments process 1424. In some embodiments, object assignments process 1424 may include enabling a graphic user interface that may use software to illustrate 3D arrangements of objects 1410, thereby assigning sound objects 1410 to specific places/spaces and/or roles whether each sound object 1410. Alternatively, a hybrid of one or more of objects 1410 may be defined within the scope of an original arrangement using a reference system. (93) In an embodiment of the invention, a form code stage 1426 may include a channel by channel assignment of INTEL (metadata). Once a user's final arrangement is decided upon, each channel to be used, whether in a virtual matrix or a physical one, may then be assigned form code which defines object's 1410 spatial attributes (if it is object-oriented) and perceptual attributes for virtual space synthesis-based objects, along with tonal attributes. Other attributes may be defined at form code stage 1426 as well (e.g. default settings, optional configuration, fold down instructions, etc.).

According to various embodiments of the invention, a delta code stage 1428 may comprise a second layer of INTEL that may be used to define a channel's changes (if any) as a result of other changing variables within a macro-micro sound event. These variables may include, for instance, master volume being elevated or attenuated to impact a sound volume's macro-micro output relationships. Certain ones of sound objects 1410 and their relationships with other objects 1410 and/or spaces may be dynamically controlled. Alternatively, other virtual field changes may be instituted when increasing or decreasing intensity levels for a macro-micro sound event. For example, a change in a rate of amplification for the virtual field versus the physical field or vice versa. Delta code stage 1428 may reconfigure a system's macro-micro dynamics via object by object coding, or channel by channel reconfiguration, etc. One non-limiting example may include a sound event coded in a format that reproduces 5.1 channel ambient signals along with six object-oriented channels. The object channels may each include a set amplitude change according to a studio referenced code, but significantly elevating the volume may create a situation in which the rate of amplification in the virtual channels may be lowered with respect to object-oriented channels during playback in order to enhance resonance and/or the performance of the reproduction. Even the object-oriented amplification curves or other parameters may be manipulated depending on scale and other parameters including active feedback systems. Delta code stage 1428 may encode INTEL that includes a predetermined recommendation for these types of changes that may be overridden during playback by an active feedback system that may recommend a different set of delta codes depending on the nature of the diagnostics received. In some instances, the user may also override the INTEL assigned by delta code stage 1428 to make changes according to their preferences rather than a studio-based reference algorithm.

In some embodiments of the invention, the recording and reproduction chain may include an alpha state stage 1430 and one or more beta state stages 1432. Alpha state stage 1430 and beta state stages 1432 may include mixing and mastering processes where form data and delta data may be defined for all micro objects and for all macro-micro relationships including fold down settings, mix down settings, default settings, etc. Alpha state stage 1430 and beta state stages 1432 may be provided as a mechanism for harmonizing an artist's original intent (when using a fully enabled macro-micro reproduction engine) with a reproduction system that may or may not be fully enabled and may or may not be configured according to a given studio reference system. Alpha state stage may produce a fully enabled version as determined by a studio reference system. This version may become the baseline for determining fold down algorithms and optional configurations, all defined as beta states (B1, B2, BN) produced at beta stages 1432. This process may then allow for beta states to be expanded, downstream, in the direction of an alpha state reproduction configuration.

In some embodiments of the invention, a gamma state stage 1434 may include a mix down from a multimode fully enabled alpha version to a complete virtual version like stereo or surround sound. In some instances, the mixdown, shown as being produced at the gamma state stage 1434, may, in an outcomes section 1436, match a configuration and output of the traditional methodology mixed down to stereo (see, for illustrative purposes, elements 1438 and 1440). In reality, this may differ, however, since the multimode method gives consumers an ability to alter a given stereo mixdown unlike the permanent mixes resulting from traditional coding schemes.

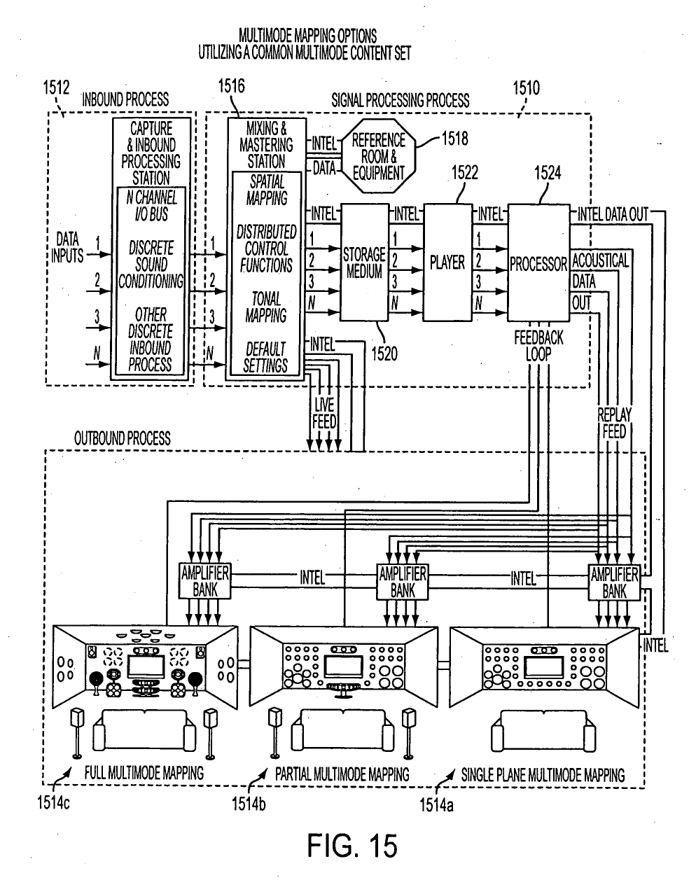

FIG. 15 illustrates an exemplary embodiment of a signal processing process 1510 according to an embodiment of the invention. Signal processing process 1510 may receive N signals that correspond to a plurality of sound objects. The N signals may be received, for example, from a capture and inbound processing station 1512. Signal processing process 1510 may process the N signals, and may output the processed N signals to any of a plurality of reproduction systems 1514 (illustrated as single plane multimode system 1514a, partial multimode system 1514b, and full multimode mapping 1514c). In some instances, the processed N signals may be output with INTEL that corresponds to the N signals.

In one embodiment of the invention, signal processing process 1510 may include a mixing and mastering station 1516, a mastering control 1518, a storage medium 1520, a player, 1522, and a processor 1524. At mixing and mastering station 1516, various mixing and/or mastering processes may be performed on the N signals. For example, INTEL corresponding to the N signals may be assigned, or captured and/or previously assigned INTEL may be edited according to automated processes or user control. Mixing and mastering station 1516 may be controlled via mastering control 1518.

According to an embodiment of the invention, the processed N signals, as well as any or all corresponding INTEL, may be recorded to a storage medium 1520. Alternatively, the processed N signals may be output without being stored. To reproduce the recorded sound objects, the processed N signals may be read from storage medium 1520 via a player 1522. Player 1522 may include a multimode player enabled to read the N processed signals, as well as the INTEL corresponding to the processed N signals if applicable.

In one embodiment of the invention, processor 1524 may receive the processed N signals read from storage medium 1520 by player 1522, and the corresponding INTEL, and may forward the N processed signals to one of systems 1514 for reproduction of the sound objects. In some instances, processor 1524 may be operatively linked with system 1514 such that processor 1524 may take into account specifications of rendering engines included in system 1514, and their arrangement, and may output customized playback data based on this information. For example, processor 1524 may sense that system 1514a includes only virtual space synthesis rendering engines, and may output playback data to system 1514a that may enhance reproduction of the sound objects via the given rendering engines of the system 1514a. Similarly, when outputting playback data to system 1514c, processor 1524 may, based on a combination of virtual space synthesis rendering engines and physical space rendering engines included in system 1514c, output playback data that may be customized to enhance reproduction of the sound objects within that specific configuration of rendering engines.

In some embodiments, a multimode content delivery and presentation system may enable different “video” presentations to be created and presented in sync with multimode audio content. In some instances, a user may be drawn to a particular song or artist but at the same time the user may not like the music VIDEO presented for the music piece they enjoy listening to multimode format. Visuals may enhance the music listening experience, and some times a consumer may not relate to a particular music video. Often times the music video may be produced by someone other than the music artist. Optional visual renderings for music presentations may enable the user to discover particular video artists that appeal to their taste regarding video renderings for music pieces, and with the appropriate permission, may purchase such alternate visual renderings to appeal more to the user during consumption. Other types of collaborations including adding to the audio tracks may be facilitated by the multimode content structure if deemed desirable for content sellers. Content sellers may block such collaborations at the time of assigning metadata to a given sound event.

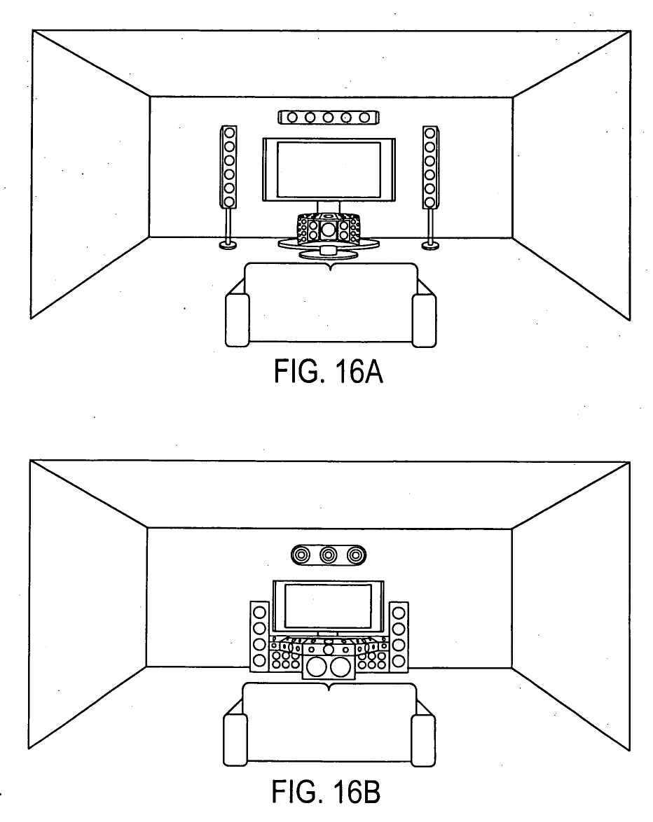

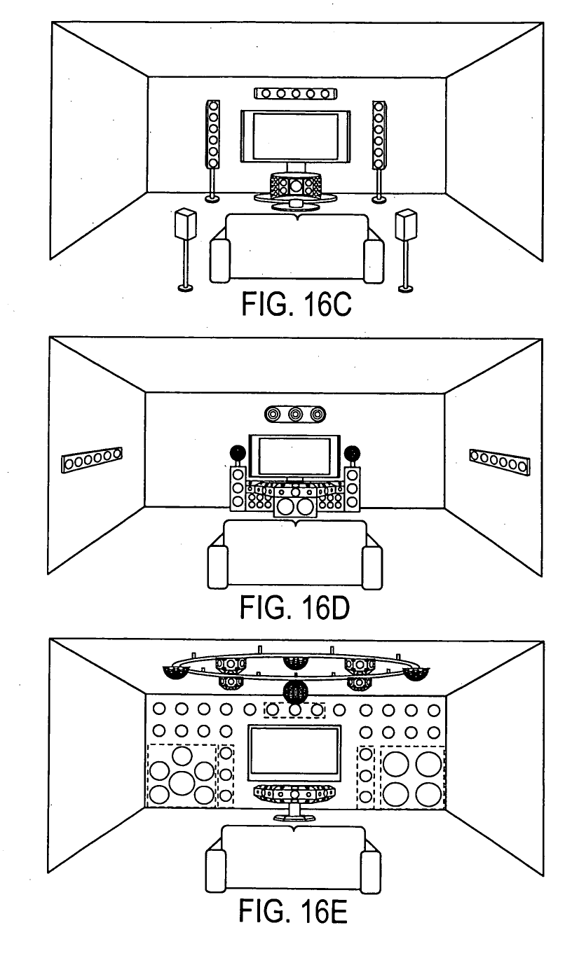

FIGS. 16A-16E are exemplary illustrations of reproduction systems that may include various configurations of physical space synthesis and/or virtual space synthesis rendering engines.

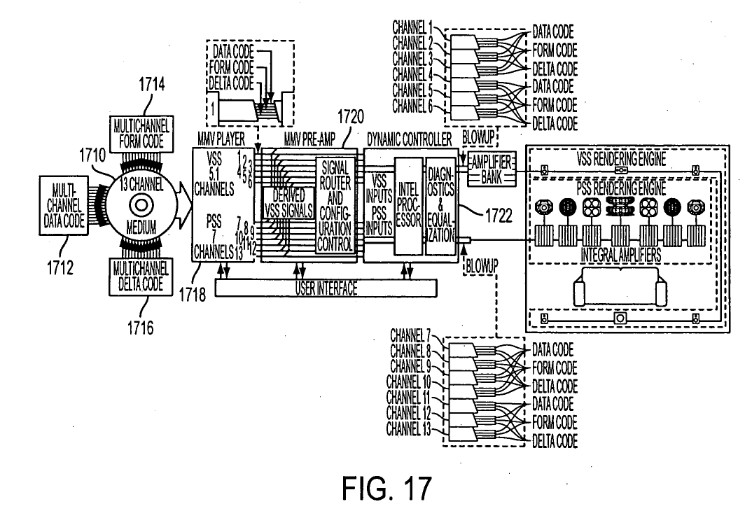

FIG. 17 illustrates an exemplary embodiment of a reproduction of sound based on an encoded multimode storage medium 1710. Multimode storage medium 1710 may be encoded with a plurality of layers of code including, for example, a data code 1712, a form code 1714, and a delta code 1716.

In some embodiments, multimode storage medium 1710 may be read by a multimode player 1718. Multimode player 1718 may read a plurality of signals that correspond to sound objects. Each signal may include some or all of data code 1712, form code 1714, and delta code 1716. Signals read by multimode player 1718 may be received by a multimode pre-amp 1720. Multimode pre-amp 1720 may, based on a configuration of rendering engines that will drive a reproduction of the sound objects, mix and/or master the signals to produce virtual space synthesis signals and/or physical space signals that correspond to the rendering engines.

According to various embodiments of the invention, processed signals produced by multimode pre-amp 1720 may be received by a dynamic controller 1722 that may process INTEL associated with the processed signals, and may transmit playback data to the rendering engines based on the processed signals and/or INTEL.

In some embodiments, some or all of multimode player 1718, multimode pre-amp 1720, and dynamic controller 1722 may be controlled by a user interface 1724. User interface 1724 may be implemented in software, and may include a graphical user interface, or user interface 1724 may include another type of interface.

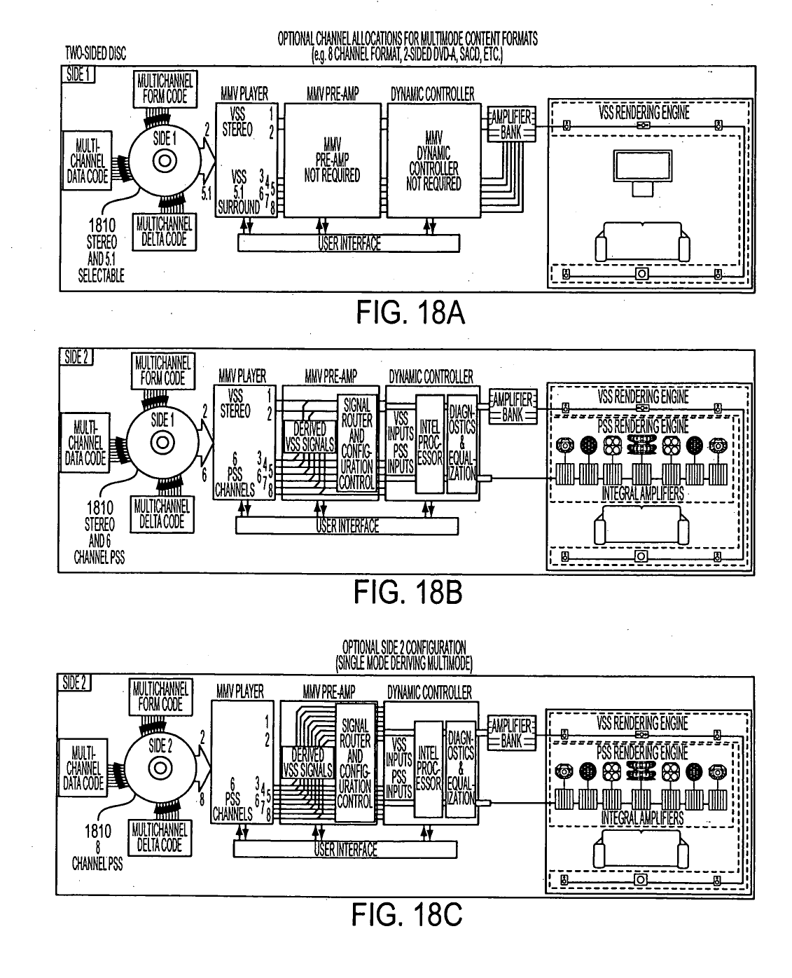

FIGS. 18A-18C illustrate exemplary embodiments of a reproduction of sound objects based on signals encoded on storage media 1810. More particularly, storage media 1810 may be encoded according to anyone of a variety of encoding formats.

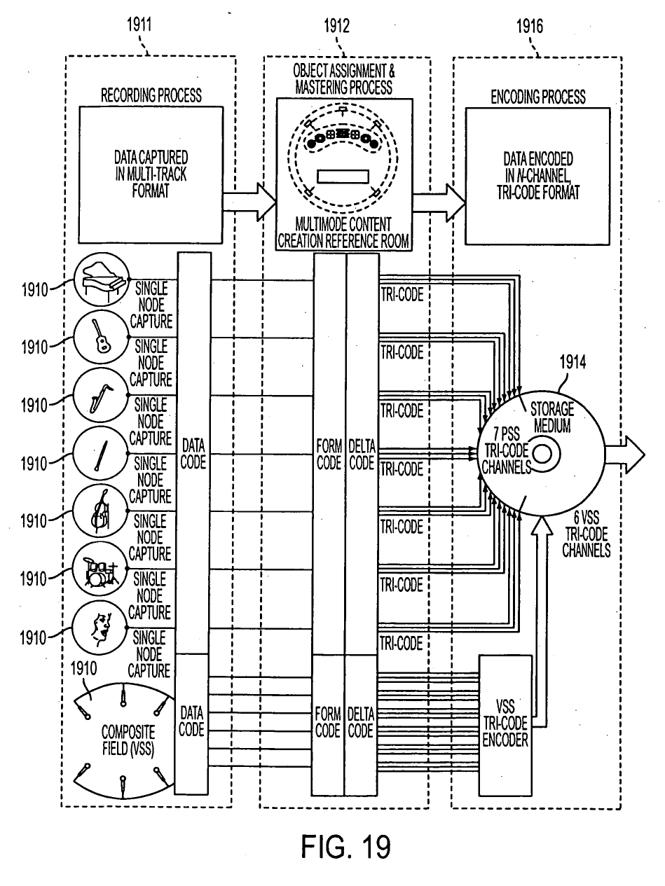

FIG. 19 is an exemplary illustration of a recording of sound objects 1910 at a recording process 1911 according to one embodiment. Recording, or capturing, sound objects 1910 may include capturing sound objects via physical space synthesis recording methods, such as using a single node (mono), virtual space synthesis recording methods (matrixed nodes), such as using a plurality of microphones to capture ambient sounds, or a combination of the two.

In some embodiments of the invention, once sound objects 1910 have been captured, signals corresponding to sound objects 1910 may be processed at an object assignment and mastering process 1912. Object assignment and mastering process 1912 may include assigning and/or editing INTEL associated with the signals, providing algorithms for folding or expanding the sound event produced by sound objects 1910, or other functionality. Object assignment and mastering process 1912 may be an automated process, may be controlled by a user, or may be both automated and controlled.

According to various embodiments of the invention, processed signals produced by object assignment and mastering process 1912 may be encoded onto a storage medium 1914 at an encoding process 1916. Encoding process 1916 may include encoding storage medium 1914 in N-channel tri-code format.

It will be appreciated that in the foregoing exemplary illustrations, connections between components and/or processes are shown for illustrative purposes only, and are intended to convey an operative link, but not necessarily a physical connection. For example, signals may be transmitted via various known wired and wireless methods such as, for instance, HDTV, satellite radio, fiber optics, terrestrial radio, DSL, etc.

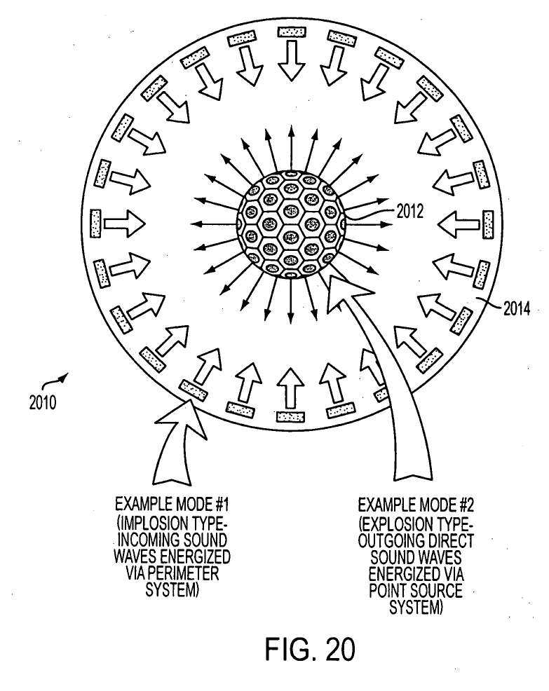

FIG. 20 illustrates an exemplary embodiment of a compound rendering engine 2010. Compound rendering engine 2010 may include a physical space synthesis rendering engine 2012 and a virtual space synthesis rendering engine 2014. Compound rendering engine 2010 may be operated according to the multimode format using multimode content to ultimately create a spatial and tonal equilibrium within the interior area of a given volume.

Another aspect of some of the embodiments of the invention relates to a system and method for recording and reproducing three-dimensional sound events using a discretized, integrated macro-micro sound volume for reproducing a 3D acoustical matrix that reproduces sound including natural propagation and reverberation. The system and method may include sound modeling and synthesis that may enable sound to be reproduced as a volumetric matrix. The volumetric matrix may be captured, transferred, reproduced, or otherwise processed, as a spatial spectra of discretely reproduced sound events with controllable macro-micro relationships.

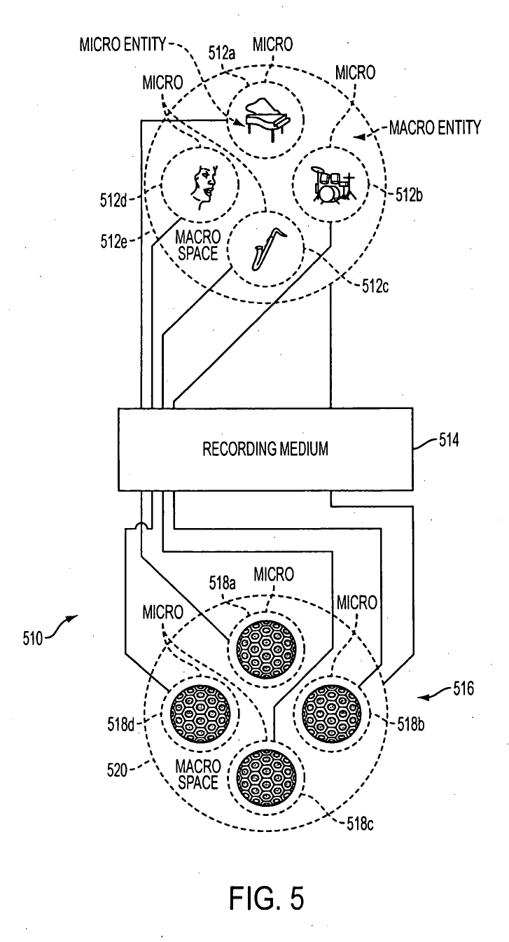

FIG. 5 illustrates an exemplary embodiment of a system 510. System 510 may include one or more recording apparatus 512 (illustrated as micro recording apparatus 512a, micro recording apparatus 512b, micro recording apparatus 512c, micro recording apparatus 512d, and macro recording apparatus 512e) for recording a sound event on a recording medium 514. Recording apparatus 512 may record the sound event as one or more discrete entities. The discrete entities may include one or more micro entities and/or one or more macro entities. A micro entity may include a sound producing entity (e.g. a sound source), or a sound affecting entity (e.g. an object or element that acoustically affects a sound). A macro entity may include one or more micro entities. System 510 may include one or more rendering engines. The rendering engine(s) may reproduce the sound event recorded on recorded medium 514 by discretely reproducing some or all of the discretely recorded entities. In some embodiments, the rendering engine may include a composite rendering engine 516. The composite rendering engine 516 may include one or more micro rendering engines 518 (illustrated as micro rendering engine 518a, micro rendering engine 518b, micro rendering engine 518c, and micro rendering engine 518d) and one or more macro engines 520. Micro rendering engines 518a-518d may reproduce one or more of the micro entities, and macro rendering engine 520 may reproduce one or more of the macro entities.

Each micro entity within the original sound event and the reproduced sound event may include a micro domain. The micro domain may include a micro entity volume of the sound characteristics of the micro entity. A macro domain of the original sound event and/or the reproduced sound event may include a macro entity that includes a plurality of micro entities. The macro domain may include one or more micro entity volumes of one or more micro entities of one or more micro domains as component parts of the macro domain. In some instances, the composite volume may be described in terms of a plurality of macro entities that correspond to a plurality of macro domains within the composite volume. A macro entity may be defined by an integration of its micro entities, wherein each micro domain may remain distinct.

Because of the propagating nature of sound, a sound event may be characterized as a macro-micro event. A exception may be a single source within an anechoic environment. This would be a rare case where a micro entity has no macro attributes, no reverb, and no incoming waves, only outgoing waves. More typically, sound event may include one or more micro entities (e.g. the sound source(s)) and one or more macro entities (e.g. the overall effects of various acoustical features of a space in which the original sound propagates and reverberates). A sound event with multiple sources may include multiple micro entities, but still may only include one macro entity (e.g. a combination of all source attributes and the attributes of the space or volume which they occur in, if applicable).

Since micro entities may be separately articulated, the separate sound sources may be separately controlled and diagnosed. In such embodiments, composite rendering apparatus 516 may form an entity network. The entity network may include micro rendering engines 518a-518d as micro entities that may also be controlled and manipulated to achieve specific macro objectives within the entity network. Macro rendering engine 520 may be included in the entity network as a macro entity that may be controlled and manipulated to achieve various macro objectives within the entity network, such as, mimicking acoustical properties of a space in which the original sound event was recorded, canceling acoustical properties of a space in which the reproduced sound event takes place, or other macro objectives. In theory, the micro entities and macro entities that make up an entity network may be discretized to a wide spectrum of defined levels. As a result, this type of entity network lends itself well to process control and the optimization of process objectives.

In some embodiments of the invention, both an original sound event and a reproduced sound event may be discretized into nearfield and farfield perspectives. This may enable articulation processes to be customized and optimized to more precisely reflect the articulation properties of an original event's corresponding nearfield and farfield entities, including appropriate scaling issues. This may be done primarily so nearfield entities may be further discretized and customized for optimum nearfield wave production on an object-oriented basis. Farfield entity reproductions may require less customization, which may enable a plurality of farfield entities to be mixed in the signal domain and rendered together as a composite event. This may work well for farfield sources such as, ambient effects, and other plane wave sources. It may also work well for virtual sound synthesis where perceptual cues are used to render virtual sources in a virtual environment. In some preferred embodiments, both nearfield physical synthesis and farfield virtual synthesis may be combined. For example, micro rendering engines 518a-518d may be implemented as nearfield entities, while macro rendering engine 520 may be implemented as a farfield entity.

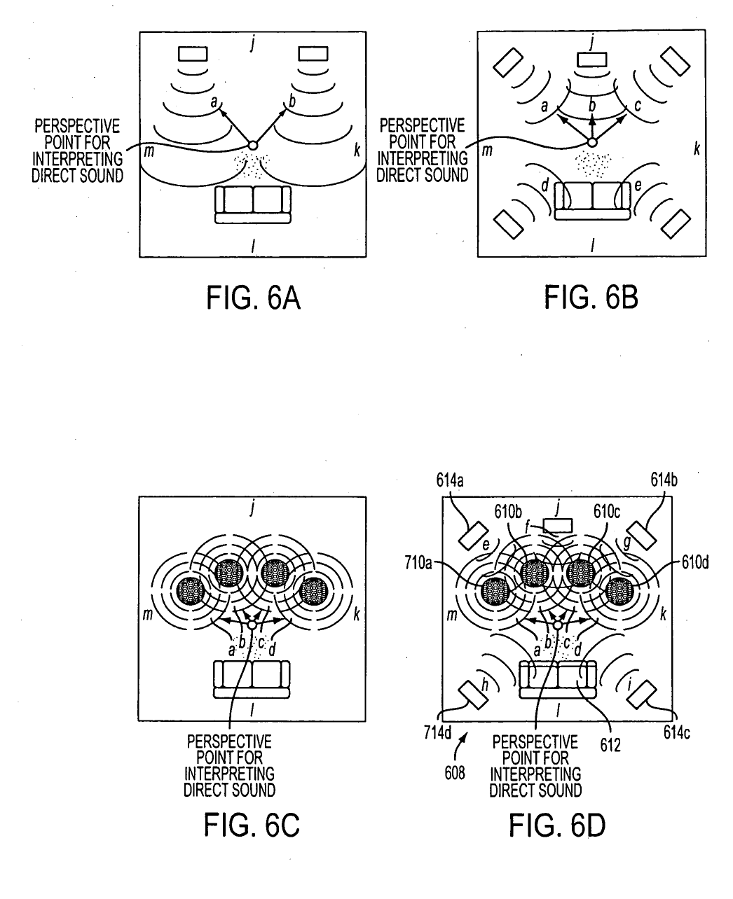

FIG. 6D illustrates an exemplary embodiment of a composite rendering engine 608 that may include one or more nearfield rendering engines 610 (illustrated as nearfield rendering engine 610a, nearfield rendering engine 610b, nearfield rendering engine 610c, and nearfield rendering engine 610d) for nearfield articulation that may be customizable, and discretized. Bringing nearfield engines 610a-610d closer to a listening area 612 may add presence and clarity to an overall articulation process. Volumetric discretization of nearfield rendering engines 610a-610d within a reproduced sound event may not only help to establish a more stable physical sound stage, it may also allow for customization of direct sound articulation, entity by entity if necessary. This can make a significant difference in overall resolution since sounds may have unique articulation attributes in terms of wave attributes, scale, directivity, etc. the nuances of which get magnified when intensity is increased.

In various embodiments of the invention, composite rendering engine 608 may include one or more farfield rendering engines 614 (illustrate as farfield rendering engine 614a, farfield rendering engine 614b, farfield rendering engine 614c, and farfield rendering engine 614d). The farfield rendering engines 614a-614d may provide a plurality of micro entity volumes included within a macro domain related to farfield entities of in a reproduced sound event.

According to one embodiment, the nearfield rendering engines 610a-610d and the farfield engines 614a-614d may work together to produce precise analogs of sound events, captured or specified. Farfield rendering engines 614a-614d may contribute to this compound approach by articulating farfield entities, such as, farfield sources, ambient effects, reflected sound, and other farfield entities, in a manner optimum to a farfield perspective. Other discretized perspectives can also be applied.

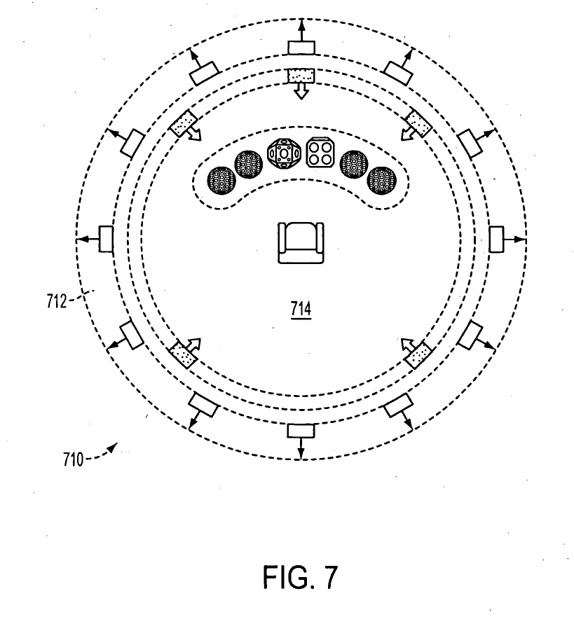

FIG. 7 illustrates an exemplary embodiment of a composite rendering engine 710 that may include an exterior noise cancellation engine 712. Exterior noise cancellation engine 712 may be used to counter some of the unwanted resonance created by an actual playback room 714. By reducing or eliminating the effects of playback room 714, “double ambience” may be reduced or eliminated leaving only the ambience of the original sound event (or of the reproduced event if source material is recorded dry) as opposed to a combined resonating effect created when the ambience of an original event's space is superimposed on the ambience of playback room 714 (“double ambience”). It may be desirable to have as much control and diagnostics over this process as possible to reduce or eliminate the unwanted effects and add or enhance desirable effects.

In some embodiments of the invention, some or all of micro entities included in an original sound event may retain discreteness throughout a transference process including the final transduction process, articulation, some or all of the entities to be mixed if so desired. For instance, to create a derived ambient effect, or be used within a generalized commercial template where a limited number of channels might be available, some or all of the discretely transferred entities may be mixed prior to articulation. Therefore, the data based functions including control over the object data that corresponds to a sound event may be enhanced to allow for both discrete object data (dry or wet) and mixed object data (matrixed according to a perceptually based algorithm) to flow through an entire processing chain to compound rendering engine that may include one or more nearfield engines and one or more farfield engines, for final articulation. In other words, object data may be representative of micro entities, such as three-dimensional sound objects, that can be independently articulated (e.g. by micro rendering engines) in addition to being part of a combined macro entity.

The virtual vs. real dichotomy (or virtual sound synthesis vs. physical sound synthesis), outlined above, may break down similar to the nearfield-farfield dichotomy. Virtual space synthesis in general may operate well with farfield architectures and physical space synthesis in general may operate well with nearfield architectures (although physical space synthesis may also integrate the use of farfield architectures in conjunction with nearfield architectures). So, the two rendering perspectives may be layered within a volume's space, one optimized for nearfield articulation, the other optimized for farfield articulation, both optimized for macro entities, and both working together to optimize the processes of volumetric amplification among other things. Other perspectives may exist that may enable sound events to be discretized to various levels.

Layering these and/or other articulation modes in this manner may improve the overall prospects for rendering sound events more optimally but may also presents new challenges, such as distinguishing when rendering should change over from virtual to real, or determining where the line between nearfield and farfield may lie. In order for rendering languages to be enabled to deal with these two dichotomies, a standardized template may be established defining nearfield discretization and farfield discretization as a function of layering real and virtual entities (other functions can be defined as well), resulting in a macro-micro rendering template for creating definable repeatable analogs.

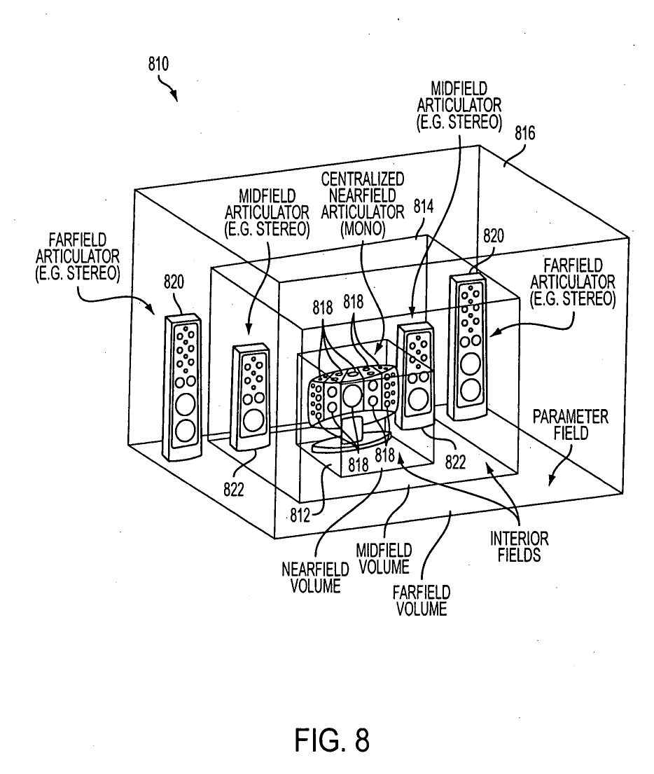

FIG. 8 illustrates an exemplary embodiment of a composite rendering engine 810 that may layer a nearfield mode 812, a midfield mode 814, and a farfield mode 816. Nearfield mode 812 may include one or more nearfield rendering engines 818. Nearfield engines 818 may be object-oriented in nature, and may be used as direct sound articulators. Farfield mode 816 may include one or more farfield rendering engines 820. Farfield rendering engines 820 may function as macro rendering engines for accomplishing macro objectives of a reproduced sound event. Farfield rendering engines 820 may be used as indirect sound articulators. Midfield mode 814 may include one or more midfield rendering engines 822. Midfield rendering engines 822 may be used as macro rendering engines, as micro rendering engines implemented as micro entities in a reproduced sound event, or to accomplish a combination of macro and micro objectives. By segregating articulation engines for direct and indirect sound, a sound space may be more optimally energized resulting in a more well defined explosive sound event.

According to various embodiments of the invention, composite rendering engine 810 may include using physical space synthesis technologies for nearfield rendering engines 818 while using virtual space synthesis technologies for farfield rendering engines 820, each optimized to work in conjunction with the other (additional functions for virtual space synthesis-physical space synthesis discretization may exist). Nearfield rendering engines 818 may be further discretized and customized.

Other embodiments may exist. For example, a primarily physical space synthesis system may be used. In such embodiments, all, or substantially all, aspects of an original sound event may be synthetically cloned and physically reproduced in an appropriately scaled space. However, the compound approach marrying virtual space synthesis and physical space synthesis may provide various enhancements, such as, economic, technical, practical, or other enhancements. However it will be appreciated that if enough space is available within a given playback venue, a sound event may be duplicated using physical space synthesis methods only.

In various embodiments of the invention, object-oriented discretization of entities may enable improvements in scaling to take place. For example, if generalizations are required due to budget or space restraints nearfield scaling issues may produce significant gains. Farfield sources may be processed and articulated using one or more separate rendering engines, which may also be scaled accordingly. As a result very impressive macro events may be reproduced within a given venue (room, car, etc.) using relatively small compound rendering engines. Sound intensification is one of audio's unique attributes.

Another aspect of the invention may relate to a transparency of sound reproduction. By discretely controlling some or all of the micro entities included in a sound event, the sound event may be recreated to compensate for one or more component colorizations through equalization as the sound event is reproduced.

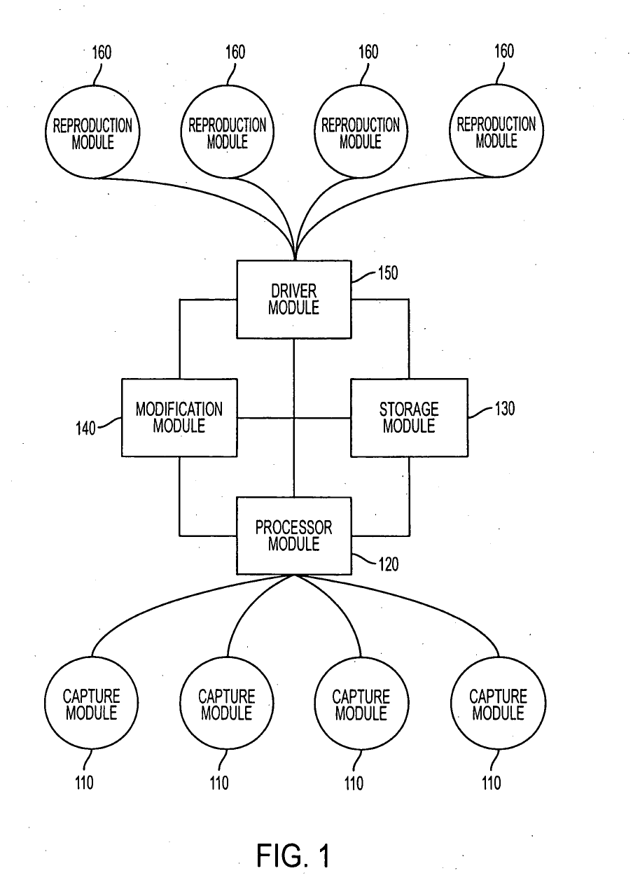

FIG. 1 illustrates a system according to an embodiment of the invention. Capture module 110 may enclose sound sources and capture a resultant sound. According to an embodiment of the invention, capture module 110 may comprise a plurality of enclosing surfaces Γa, with each enclosing surface Γa associated with a sound source. Sounds may be sent from capture module 110 to processor module 120. According to an embodiment of the invention, processor module 120 may be a central processing unit (CPU) or other type of processor. Processor module 120 may perform various processing functions, including modeling sound received from capture module 10 based on predetermined parameters (e.g., amplitude, frequency, direction, formation, time, etc.). Processor module 120 may direct information to storage module 130. Storage module 130 may store information, including modeled sound. Modification module 140 may permit captured sound to be modified. Modification may include modifying volume, amplitude, directionality, and other parameters. Driver module 150 may instruct reproduction modules 160 to produce sounds according to a model. According to an embodiment of the invention, reproduction module 160 may be a plurality of amplification devices and loudspeaker clusters, with each loudspeaker cluster associated with a sound source. Other configurations may also be used. The components of FIG. 1 will now be described in more detail.

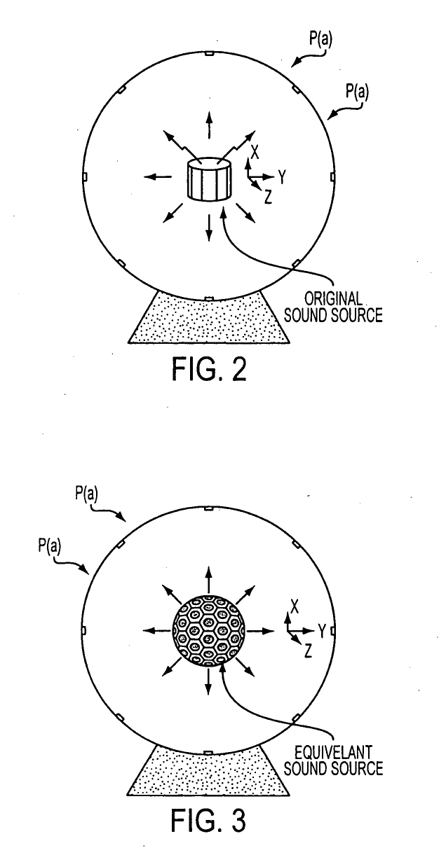

FIG. 2 depicts a capture module 110 for implementing an embodiment of the invention. As shown in the embodiment of FIG. 2, one aspect of the invention comprises at least one sound source located within an enclosing (or partially enclosing) surface Γa, which for convenience is shown to be a sphere. Other geometrically shaped enclosing surface Γa configurations may also be used. A plurality of transducers are located on the enclosing surface Γa at predetermined locations. The transducers are preferably arranged at known locations according to a predetermined spatial configuration to permit parameters of a sound field produced by the sound source to be captured. More specifically, when the sound source creates a sound field, that sound field radiates outwardly from the source over substantially 360°. However, the amplitude of the sound will generally vary as a function of various parameters, including perspective angle, frequency and other parameters. That is to say that at very low frequencies (˜20 Hz), the radiated sound amplitude from a source such as a speaker or a musical instrument is fairly independent of perspective angle (omni-directional). As the frequency is increased, different directivity patterns will evolve, until at very high frequency (˜20 kHz), the sources are very highly directional. At these high frequencies, a typical speaker has a single, narrow lobe of highly directional radiation centered over the face of the speaker, and radiates minimally in the other perspective angles. The sound field can be modeled at an enclosing surface Γa by determining various sound parameters at various locations on the enclosing surface Γa. These parameters may include, for example, the amplitude (pressure), the direction of the sound field at a plurality of known points over the enclosing surface and other parameters.

According to one embodiment of the present invention, when a sound field is produced by a sound source, the plurality of transducers measures predetermined parameters of the sound field at predetermined locations on the enclosing surface over time. As detailed below, the predetermined parameters are used to model the sound field.

For example, assume a spherical enclosing surface Γa with N transducers located on the enclosing surface Γa. Further consider a radiating sound source surrounded by the enclosing surface, Γa (FIG. 2). The acoustic pressure on the enclosing surface Γa due to a soundfield generated by the sound source will be labeled P(a). It is an object to model the sound field so that the sound source can be replaced by an equivalent source distribution such that anywhere outside the enclosing surface Γa, the sound field, due to a sound event generated by the equivalent source distribution, will be substantially identical to the sound field generated by the actual sound source (FIG. 3). This can be accomplished by reproducing acoustic pressure P(a) on enclosing surface Γa with sufficient spatial resolution. If the sound field is reconstructed on enclosing surface Γa, in this fashion, it will continue to propagate outside this surface in its original manner.

While various types of transducers may be used for sound capture, any suitable device that converts acoustical data (e.g., pressure, frequency, etc.) into electrical, or optical data, or other usable data format for storing, retrieving, and transmitting acoustical data“may be used.

Processor module 120 may be central processing unit (CPU) or other processor. Processor module 120 may perform various processing functions, including modeling sound received from capture module 110 based on predetermined parameters (e.g., amplitude, frequency, direction, formation, time, etc.), directing information, and other processing functions. Processor module 120 may direct information between various other modules within a system, such as directing information to one or more of storage module 130, modification module 140, or driver module 150.

Storage module 130 may store information, including modeled sound. According to an embodiment of the invention, storage module may store a model, thereby allowing the model to be recalled and sent to modification module 140 for modification, or sent to driver module 150 to have the model reproduced.

Modification module 140 may permit captured sound to be modified. Modification may include modifying volume, amplitude, directionality, and other parameters. While various aspects of the invention enable creation of sound that is substantially identical to an original sound field, purposeful modification may be desired. Actual sound field models can be modified, manipulated, etc. for various reasons including customized designs, acoustical compensation factors, amplitude extension, macro/micro projections, and other reasons. Modification module 140 may be software on a computer, a control board, or other devices for modifying a model.

Driver module 150 may instruct reproduction modules 160 to produce sounds according to a model. Driver module 150 may provide signals to control the output at reproduction modules 160. Signals may control various parameters of reproduction module 160, including amplitude, directivity, and other parameters. FIG. 3 depicts a reproduction module 160 for implementing an embodiment of the invention. According to an embodiment of the invention, reproduction module 160 may be a plurality of amplification devices and loudspeaker clusters, with each loudspeaker cluster associated with a sound source.

Preferably there are N transducers located over the enclosing surface Γa of the sphere for capturing the original sound field and a corresponding number N of transducers for reconstructing the original sound field. According to an embodiment of the invention, there may be more or less transducers for reconstruction as compared to transducers for capturing. Other configurations may be used in accordance with the teachings of the present invention.

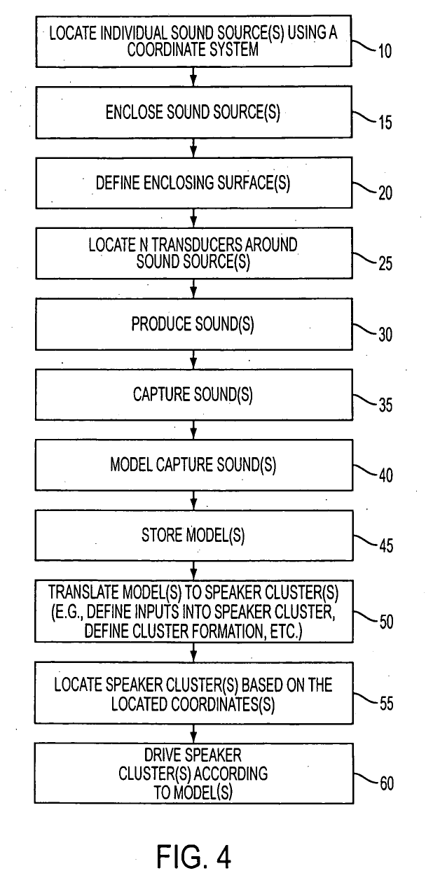

FIG. 4 illustrates a flow-chart according to an embodiment of the invention wherein a number of sound sources are captured and recreated. Individual sound source(s) may be located using a coordinate system at step 10. Sound source(s) may be enclosed at step 15, enclosing surface Γa may be defined at step 20, and N transducers may be located around enclosed sound source(s) at step 25. According to an embodiment of the invention, as illustrated in FIG. 2, transducers may be located on the enclosing surface Γa. Sound(s) may be produced at step 30, and sound(s) may be captured by transducers at step 35. Captured sound(s) may be modeled at step 40, and model(s) may be stored at step 45. Model(s) may be translated to speaker cluster(s) at step 50. At step 55, speaker cluster(s) may be located based on located coordinate(s). According to an embodiment of the invention, translating a model may comprise defining inputs into a speaker cluster. At step 60, speaker cluster(s) may be driven according to each model, thereby producing a sound. Sound sources may be captured and recreated individually (e.g., each sound source in a band is individually modeled) or in groups. Other methods for implementing the invention may also be used.

According to an embodiment of the invention, as illustrated in FIG. 2, sound from a sound source may have components in three dimensions. These components may be measured and adjusted to modify directionality. For this reproduction system, it is desired to reproduce the directionality aspects of a musical instrument, for example, such that when the equivalent source distribution is radiated within some arbitrary enclosure, it will sound just like the original musical instrument playing in this new enclosure. This is different from reproducing what the instrument would sound like if one were in fifth row center in Carnegie Hall within this new enclosure. Both can be done, but the approaches are different. For example, in the case of the Carnegie Hall situation, the original sound event contains not only the original instrument, but also its convolution with the concert hail impulse response. This means that at the listener location, there is the direct field (or outgoing field) from the instrument plus the reflections of the instrument off the walls of the hail, coming from possibly all directions over time. To reproduce this event within a playback environment, the response of the playback environment should be canceled through proper phasing, such that substantially only the original sound event remains. However, we would need to fit a volume with the inversion, since the reproduced field will not propagate as a standing wave field which is characteristic of the original sound event (i.e., waves going in many directions at once). If, however, it is desired to reproduce the original instrument's radiation pattern without the reverberatory effects of the concert hail, then the field will be made up of outgoing waves (from the source), and one can fit the outgoing field over the surface of a sphere surrounding the original instrument. By obtaining the inputs to the array for this case, the field will propagate within the playback environment as if the original instrument were actually playing in the playback room.

So, the two cases are as follows:

1. To reproduce the Carnegie Hall event, one needs to know the total reverberatory sound field within a volume, and fit that field with the array subject to spatial Nyquist convergence criteria. There would be no guarantee however that the field would converge anywhere outside this volume.

2. To reproduce the original instrument alone, one needs to know the outgoing (or propagating) field only over a circumscribing sphere, and fit that field with the array subject to convergence criteria on the sphere surface. If this field is fit with sufficient convergence, the field will continue to propagate within the playback environment as if the original instrument were actually playing within this volume.

Thus, in one case, an outgoing sound field on enclosing surface Γa has either been obtained in an anechoic environment or reverberatory effects of a bounding medium have been removed from the acoustic pressure P(a). This may be done by separating the sound field into its outgoing and incoming components. This may be performed by measuring the sound event, for example, within an anechoic environment, or by removing the reverberatory effects of the recording environment in a known manner. For example, the reverberatory effects can be removed in a known manner using techniques from spherical holography. For example, this requires the measurement of the surface pressure and velocity on two concentric spherical surfaces. This will permit a formal decomposition of the fields using spherical harmonics, and a determination of the outgoing and incoming components comprising the reverberatory field. In this event, we can replace the original source with an equivalent distribution of sources within enclosing surface Γa. Other methods may also be used.

By introducing a function Hᵢⱼ(ω), and defining it as the transfer function between source point “i” (of the equivalent source distribution) to field point “j” (on the enclosing surface Γa), and denoting the column vector of inputs to the sources χᵢ(ω), i=1, 2 . . . N, as X, the column vector of acoustic pressures P(a)ⱼ j=1, 2, . . . N, on enclosing surface Γa as P, and the N×N transfer function matrix as H, then a solution for the independent inputs required for the equivalent source distribution to reproduce the acoustic pressure P(a) on enclosing surface Γa may be expressed as follows
X=H⁻¹ P (Eqn. 1)

Given a knowledge of the acoustic pressure P(a) on the enclosing surface Γa, and a knowledge of the transfer function matrix (H), a solution for the inputs X may be obtained from Eqn. (1), subject to the condition that the matrix H⁻¹ is nonsingular.

The spatial distribution of the equivalent source distribution may be a volumetric array of sound sources, or the array may be placed on the surface of a spherical structure, for example, but is not so limited. Determining factors for the relative distribution of the source distribution in relation to the enclosing surface Γa may include that they lie within enclosing surface Γa, that the inversion of the transfer function matrix, H⁻¹, is nonsingular over the entire frequency range of interest, or other factors. The behavior of this inversion is connected with the spatial situation and frequency response of the sources through the appropriate Green's Function in a straightforward manner.

The equivalent source distributions may comprise one or more of:
a) piezoceramic transducers,
b) Polyvinyldine Flouride (PVDF) actuators,
c) Mylar sheets,
d) vibrating panels with specific modal distributions,
e) standard electroacoustic transducers,

with various responses, including frequency, amplitude, and other responses, sufficient for the specific requirements (e.g., over a frequency range from about 20 Hz to about 20 kHz.

Concerning the spatial sampling criteria in the measurement of acoustic pressure P(a) on the enclosing surface Γa, from Nyquist sampling criteria, a minimum requirement may be that a spatial sample be taken at least one half the highest wavelength of interest. For 20 kHz in air, this requires a spatial sample to be taken every 8 mm. For a spherical enclosing Γa surface of radius 2 meters, this results in approximately 683,600 sample locations over the entire surface. More or less may also be used.

Concerning the number of sources in the equivalent source distribution for the reproduction of acoustic pressure P(a), it is seen from Eqn. (1) that as many sources may be required as there are measurement locations on enclosing surface Γa. According to an embodiment of the invention, there may be more or less sources when compared to measurement locations. Other embodiments may also be used.

Concerning the directivity and amplitude variational capabilities of the array, it is an object of this invention to allow for increasing amplitude while maintaining the same spatial directivity characteristics of a lower amplitude response. This may be accomplished in the manner of solution as demonstrated in Eqn. 1, wherein now we multiply the matrix P by the desired scalar amplitude factor, while maintaining the original, relative amplitudes of acoustic pressure P(a) on enclosing surface Γa.

It is another object of this invention to vary the spatial directivity characteristics from the actual directivity pattern. This may be accomplished in a straightforward manner as in beam forming methods.

According to another aspect of the invention, the stored model of the sound field may be selectively recalled to create a sound event that is substantially the same as, or a purposely modified version of, the modeled and stored sound. As shown in FIG. 3, for example, the created sound event may be implemented by defining a predetermined geometrical surface (e.g., a spherical surface) and locating an array of loudspeakers over the geometrical surface. The loudspeakers are preferably driven by a plurality of independent inputs in a manner to cause a sound field of the created sound event to have desired parameters at an enclosing surface (for example a spherical surface) that encloses (or partially encloses) the loudspeaker array. In this way, the modeled sound field can be recreated with the same or similar parameters (e.g., amplitude and directivity pattern) over an enclosing surface. Preferably, the created sound event is produced using an explosion type sound source, i.e., the sound radiates outwardly from the plurality of loudspeakers over 360° or some portion thereof.

One advantage of the present invention is that, once a sound source has been modeled for a plurality of sounds and a sound library has been established, the sound reproduction equipment can be located where the sound source used to be to avoid the need for the sound source, or to duplicate the sound source, synthetically as many times as desired.

The present invention takes into consideration the magnitude and direction of an original sound field over a spherical, or other surface, surrounding the original sound source. A synthetic sound source (for example, an inner spherical speaker cluster) can then reproduce the precise magnitude and direction of the original sound source at each of the individual transducer locations. The integral of all of the transducer locations (or segments) mathematically equates to a continuous function which can then determine the magnitude and direction at any point along the surface, not just the points a which the transducers are located.

According to another embodiment of the invention, the accuracy of a reconstructed sound field can be objectively determined by capturing and modeling the synthetic sound event using the same capture apparatus configuration and process as used to capture the original sound event. The synthetic sound source model can then be juxtaposed with the original sound source model to determine the precise differentials between the two models. The accuracy of the sonic reproduction can be expressed as a function of the differential measurements between the synthetic sound source model and the original sound source model. According to an embodiment of the invention, comparison of an original sound event model and a created sound event model may be performed using processor module 120.

Alternatively, the synthetic sound source can be manipulated in a variety of ways to alter the original sound field. For example, the sound projected from the synthetic sound source can be rotated with respect to the original sound field without physically moving the spherical speaker cluster. Additionally, the volume output of the synthetic source can be increased beyond the natural volume output levels of the original sound source. Additionally, the sound projected from the synthetic sound source can be narrowed or broadened by changing the algorithms of the individually powered loudspeakers within the spherical network of loudspeakers. Various other alterations or modifications of the sound source can be implemented.

By considering the original sound source to be a point source within an enclosing surface Γa, simple processing can be performed to model and reproduce the sound.

According to an embodiment, the sound capture occurs in an anechoic chamber or an open air environment with support structures for mounting the encompassing transducers. However, if other sound capture environments are used, known signal processing techniques can be applied to compensate for room effects. However, with larger numbers of transducers, the “compensating algorithms” can be somewhat more complex.

Once the playback system is designed based on given criteria, it can, from that point forward, be modified for various purposes, including compensation for acoustical deficiencies within the playback venue, personal preferences, macro/micro projections, and other purposes. An example of macro/micro projection is designing a synthetic sound source for various venue sizes. For example, a macro projection may be applicable when designing a synthetic sound source for an outdoor amphitheater. A micro projection may be applicable for an automobile venue. Amplitude extension is another example of macro/micro projection. This may be applicable when designing a synthetic sound source to perform 10 or 20 times the amplitude (loudness) of the original sound source. Additional purposes for modification may be narrowing or broadening the beam of projected sound (i.e., 360° reduced to 180°, etc.), altering the volume, pitch, or tone to interact more efficiently with the other individual sound sources within the same sound field, or other purposes.

The present invention takes into consideration the “directivity characteristics” of a given sound source to be synthesized. Since different sound sources (e.g., musical instruments) have different directivity patterns the enclosing surface and/or speaker configurations for a given sound source can be tailored to that particular sound source. For example, horns are very directional and therefore require much more directivity resolution (smaller speakers spaced closer together throughout the outer surface of a portion of a sphere, or other geometric configuration), while percussion instruments are much less directional and therefore require less directivity resolution (larger speakers spaced further apart over the surface of a portion of a sphere, or other geometric configuration).

According to another embodiment of the invention, a computer usable medium having computer readable program code embodied therein for an electronic competition may be provided. For example, the computer usable medium may comprise a CD ROM, a floppy disk, a hard disk, or any other computer usable medium. One or more of the modules of system 100 may comprise computer readable program code that is provided on the computer usable medium such that when the computer usable medium is installed on a computer system, those modules cause the computer system to perform the functions described.

According to one embodiment, processor, module 120, storage module 130, modification module 140, and driver module 150 may comprise computer readable code that, when installed on a computer, perform the functions described above. Also, only some of the modules may be provided in computer readable code.

According to one specific embodiment of the present invention, a system may comprise components of a software system. The system may operate on a network and may be connected to other systems sharing a common database. According to an embodiment of the invention, multiple analog systems (e.g., cassette tapes) may operate in parallel to each other to accomplish the objections and functions of the invention. Other hardware arrangements may also be provided.

In some embodiments of the invention, sound may be modeled and synthesized based on an object-oriented discretization of a sound volume starting from focal regions inside a volumetric matrix and working outward to the perimeter of the volumetric matrix. An inverse template may be applied for discretizing the perimeter area of the volumetric matrix inward toward a focal region.

In applying volumetric geometry to objectively define volumetric space and direction parameters in terms of the placement of sources, the scale between sources and between room size and source size, the attributes of a given volume or space, movement algorithms for sources, etc., may be done using a variety of evaluation techniques. For example, a method of standardizing the volumetric modeling process may include applying a focal point approach where a point of orientation is defined to be a “focal point” or “focal region” for a given sound volume.

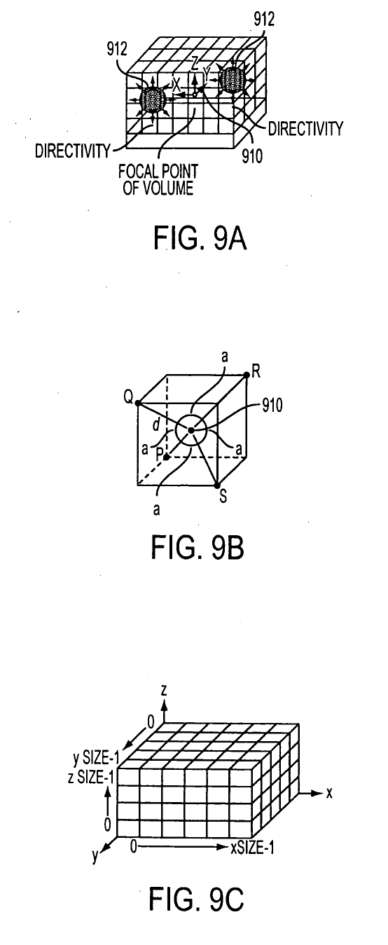

According to various embodiments of the invention, focal point coordinates for any volume may be computed from dimensional data for a given volume which may be measured or assigned. FIG. 9A illustrates an exemplary embodiment of a focal point 910 located amongst one or more micro entities 912 of a sound event. Since a volume may have a common reference point, focal point 910 for example, everything else may be defined using a three dimensional coordinate system with volume focal points serving as a common origin, such as an exemplary coordinate system illustrated in FIG. 9B. Other methods for defining volumetric parameters may be used as well, including a tetrahedral mesh illustrated in FIG. 9C, or other methods. Some or all of the volumetric computation may be performed via computerized processing. Once a volume's macro-micro relationships are determined based on a common reference point (e.g. its focal point), scaling issues may be applied in an objective manner. Data based aspects (e.g. content) can be captured (or defined) and routed separately for rendering via a compound rendering engine.

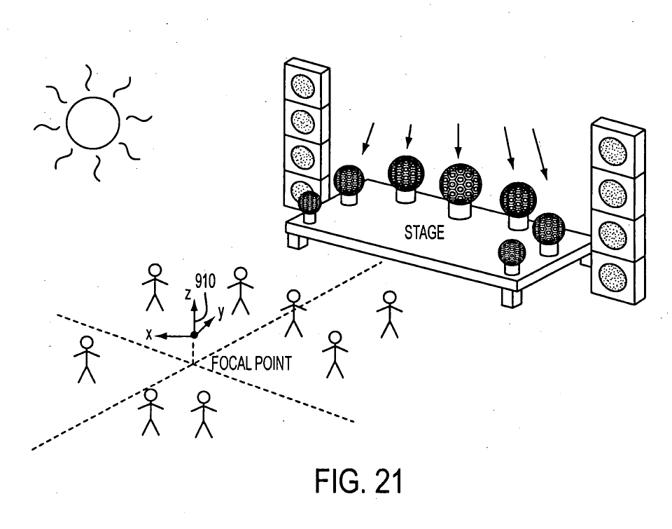

FIG. 21 illustrates an exemplary embodiment that may be implemented in applications that occur in open space without full volumetric parameters (e.g. a concert in an outdoor space), the missing volumetric parameters may be assigned based on sound propagation laws or they may be reduced-to minor roles since only ground reflections and intraspace dynamics among sources may be factored into a volumetric equation in terms of reflected sound and other ambient features. However even under these conditions a sound event's focal point 910 (used for scaling purposes among other things) may still be determined by using area dimension and height dimension for an anticipated event location.

By establishing an area based focal point (i.e. focal point 910) with designated height dimensions even outdoor events and other sound events not occurring in a structured volume may be appropriately scaled and translated from reference models.

Other embodiments, uses and advantages of the present invention will be apparent to those skilled in the art from consideration of the specification and practice of the invention disclosed herein. The specification and examples should be considered exemplary only.

What is claimed is:

1. A sound player device comprising:
means for individually receiving N sound objects, wherein each individual sound object corresponds to a single sound source and comprises sound information and form information, the sound information being related to sounds produced by the single sound source and the form information being related to one or more other characteristics of the sound source;
means for assigning the N sound objects to M output channels;
means for receiving synthesis information, the synthesis information being associated with one or more schemes for assigning the N sound objects to the M output channels;
means for determining one or more characteristics of the M output channels; and
means for selecting a default scheme from the schemes for assigning the N sound objects to the M output channels based on the one or more characteristics of the M output channels,
wherein the means for assigning the N sound objects to the M output channels assigns the N sound objects to the M output channels based on the default scheme.

2. The sound player device of claim 1, wherein the sound information comprises tonal information and amplitude information.

3. The sound player device of claim 2, wherein the sound information comprises a mono soundtrack.

4. The sound player device of claim 1, wherein the form information comprises one or more of a directivity pattern, position information, or an object movement algorithm.

5. The sound player device of claim 1, further comprising means for enabling a user to reject the default scheme and manually select another one of the schemes for assigning the N sound objects to the M output channels, wherein the means for assigning the N sound objects to the M output channels assigns the N sound objects to the M output channels based on the manually selected scheme.

6. The sound player device of claim 1, further comprising means for enabling a user to modify the default scheme, wherein the assignment of the N sound objects to the M output channels by the means for assigning the N sound objects to the M output channels reflects the modifications to the default scheme.

7. The sound player device of claim 1, wherein the one or more characteristics of the M output channels comprises one or more of a number of output channels, a frequency response of one or more of the M output channels, a directivity pattern of one or more of the M output channels, or a power of one or more of the M output channels.

8. The sound player device of claim 1, wherein the form information establishes an integral wave starting point, a relative position, and a scale for each of the N sound objects.

9. A method comprising:
individually receiving N sound objects, wherein each individual sound object corresponds to a single sound source and comprises sound information and form information, the sound information being related to sounds produced by the single sound source and the form information being related to one or more other characteristics of the sound source;
receiving synthesis information, the synthesis information being associated with one or more schemes for assigning the N sound objects to the M output channels;
determining one or more characteristics of the M output channels;
selecting a default scheme from the schemes for assigning the N sound objects to the M output channels based on the one or more characteristics of the M output channels;
and
assigning the N sound objects to the M output channels based on the default scheme.

10. The method of claim 9, wherein the sound information comprises tonal information and amplitude information.

11. The method of claim 10, wherein the sound information comprises a mono soundtrack.

12. The method of claim 9, wherein the form information comprises one or more of a directivity pattern, position information, or an object movement algorithm.

13. The method of claim 9, further comprising:
enabling a user to reject the default scheme;
enabling the user to manually select another one of the schemes for assigning the N sound objects to the M output channels; and
assigning the N sound objects to the M output channels based on the manually selected scheme.

14. The method of claim 9, further comprising enabling a user to modify the default scheme, wherein the assignment of the N sound objects to the M output channels reflects the modifications to the default scheme.

15. The method of claim 9, wherein the one or more characteristics of the M output channels comprises one or more of a number of output channels, a frequency response of one or more of the M output channels, a directivity pattern of one or more of the M output channels, or a power of one or more of the M output channels.

16. The method of claim 9, wherein the form information establishes an integral wave starting point, a relative position, and a scale for each of the N sound objects.

17. A user interface for controlling a sound player device, the user interface comprising:
means for presenting N sound objects to a user, wherein each individual sound object corresponds to a single sound source and comprises sound information and form information, the sound information being related to sounds produced by the single sound source and the form information being related to one or more other characteristics of the sound source;
means for presenting an assignment of the N sound objects to M output channels to the user;
means for presenting one or more characteristics of the M output channels to the user; and
means for enabling the user to modify the form information associated with one or more of the N sound objects.

18. The user interface of claim 17, wherein the form information comprises one or more of a directivity pattern, position information, or an object movement algorithm.

19. The user interface of claim 17, wherein the form information establishes an integral wave starting point, a relative position, and a scale for each of the N sound objects.

20. The user interface of claim 17, wherein the one or more characteristics of the M output channels comprises one or more of a number of output channels, a frequency response of one or more of the M output channels, a directivity pattern of one or more of the M output channels, or a power of one or more of the M output channels.
